(19) United States
(12) Patent Application Publication
(10) Pub. No.: US 2018/0310236 A1
(43) Pub. Date: Oct. 25, 2018

(54) MULTI-SUBSCRIBER IDENTITY MODULE CARD USER EQUIPMENT WITH SUBSCRIBER SELECTION

(71) Applicant: QUALCOMM Incorporated, San Diego, CA (US)

(72) Inventors: Akash KUMAR, Hyderabad (IN); Ankita., Hyderabad (IN); Ashutosh GIRI, Hyderabad (IN)

(21) Appl. No.: 15/493,020

(22) Filed: Apr. 20, 2017

(51) Int. Cl. H04W 48/18; H04W 8/18; H04W 76/02; H04M 1/2745; H04W 8/20; H04M 1/725

(52) U.S. Cl. CPC H04W 48/18; H04W 8/183; H04M 1/72522; H04M 1/274525; H04W 8/20; H04W 76/025

(57) ABSTRACT

In an aspect of the disclosure, a method, a computer-readable medium, and an apparatus are provided. For example, the apparatus may display a set of communication parameters associated with initiating a wireless communication using a first communication network associated with the first SIM card and a second communication network associated with the second SIM card. The apparatus may also receive a first selection of at least one first communication parameter of the set of communication parameters to display for each of the first network associated with the first SIM card and the second communication network associated with the second SIM card. The apparatus may further maintain the first selection of the at least one first communication parameter of the set of communication parameters to display for each of the first network associated with the first SIM card and the second communication network associated with the second SIM card.

### BACKGROUND

### Field

The present disclosure relates generally to a multi-subscriber identity module (SIM) user equipment (UE) configured to maintain a selection of at least one first communication parameter of a set of communication parameters to display for each of a first network associated with a first SIM card and a second communication network associated with a second SIM card when a wireless communication request is initiated at the multi-SIM card UE.

### Background

A SIM card is a portable memory chip that may be used in a wireless device (e.g., a UE, smart phone, mobile phone, tablet device, laptop computer, etc.) that operates on a wireless communication network (e.g., a Global System for Mobile Communications (GSM) network, a Long Term Evolution (LTE) network, etc.). A SIM card may be used to maintain personal information of a user associated with the UE, including the user's mobile number, address book, text messages, and other data.

A multi-SIM card UE is a wireless device that may include slots for two or more SIM cards, and may maintain multiple mobile numbers (e.g., one mobile number for each SIM card), one or more contact lists (e.g., one contact list per SIM card and/or a master contact list that includes all contacts associated with all SIM cards), and/or communication data (e.g., call histories, text message histories, etc.) associated with different mobile numbers, different SIM cards, and/or different communication networks.

With a multi-SIM card UE, a user may send and/or receive wireless communications using any of the mobile numbers associated with one of the SIM cards maintained at the UE. For example, a user may be able to send and/or receive wireless communications associated with a work mobile number and a personal mobile number using the same device. When a user wants to initiate a wireless communication (e.g., mobile voice communication, wireless data communication, wireless text message, wireless video communication, etc.), the user may not have visibility to certain communication parameters that the user may want to consider before choosing a SIM card and/or mobile phone number to initiate a wireless communication.

There is a need to provide visibility of communication parameters associated with mobile phone numbers maintained at a multi-SIM UE before initiating wireless communication using a mobile number maintained at the multi-SIM UE.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

With a multi-SIM card UE, a user may send and/or receive wireless communications using any of the phone numbers associated with the multiple SIM cards maintained at the UE. For example, a user may be able to send and/or receive wireless communications associated with a work mobile number and a personal mobile number using the same device. When a user wants to initiate a wireless communication (e.g., mobile voice communication, wireless data communication, wireless text message, wireless video communication, etc.), the user may not have visibility of certain communication parameters that the user may want to consider before choosing a mobile number to initiate the wireless communication.

There is a need to provide visibility of communication parameters associated with mobile phone numbers maintained at a multi-SIM UE before initiating wireless communication using a mobile number maintained at the multi-SIM UE.

The present disclosure provides a solution to the limited visibility of communication parameters by maintaining a selection of at least one first communication parameter of a set of communication parameters, and displaying the at least one first communication parameter for each of a first network associated with a first SIM card and a second communication network associated with a second SIM card when a wireless communication request is initiated at the multi-SIM card UE.

In an aspect of the disclosure, a method, a computer-readable medium, and an apparatus are provided. For example, the apparatus may display a set of communication parameters associated with initiating a wireless communication using a first communication network associated with the first SIM card and initiating a wireless communication using a second communication network associated with the second SIM card. The apparatus may also receive a first selection of at least one first communication parameter of the set of communication parameters to display for each of the first network associated with the first SIM card and the second communication network associated with the second SIM card. The apparatus may further maintain the first selection of the at least one first communication parameter of the set of communication parameters to display for each of the first network associated with the first SIM card and the second communication network associated with the second SIM card. In certain aspects, the first selection of the at least one first communication parameter of the set of communication parameters to display for each of the first network associated with the first SIM card and the second communication network associated with the second SIM card may be maintained until the user changes the parameters to be displayed.

In another aspect, the apparatus may include a memory, and at least one processor coupled to the memory. The apparatus (e.g., the at least one processor of the apparatus) may be configured to display a set of communication parameters associated with initiating a wireless communication using a first communication network associated with the first SIM card and initiating a wireless communication using a second communication network associated with the second SIM card. The apparatus (e.g., the at least one processor of the apparatus) may also be configured to receive a first selection of at least one first communication parameter of the set of communication parameters to display for each of the first network associated with the first SIM card and the second communication network associated with the second SIM card. The apparatus (e.g., the at least one processor of the apparatus) may further be configured to maintain the first selection of the at least one first communication parameter of the set of communication parameters to display for each of the first network associated with the first SIM card and the second communication network associated with the second SIM card. In certain aspects, the first selection of the at least one first communication parameter of the set of communication parameters to display for each of the first network associated with the first SIM card and the second communication network associated with the second SIM card may be maintained until the user changes the parameters to be displayed.

In a further aspect, the apparatus may include means for displaying a set of communication parameters associated with initiating a wireless communication using a first communication network associated with the first SIM card and initiating a wireless communication using a second communication network associated with the second SIM card. The apparatus may also include means for receiving a first selection of at least one first communication parameter of the set of communication parameters to display for each of the first network associated with the first SIM card and the second communication network associated with the second SIM card. The apparatus may further include means for maintaining the first selection of the at least one first communication parameter of the set of communication parameters to display for each of the first network associated with the first SIM card and the second communication network associated with the second SIM card. In certain aspects, the first selection of the at least one first communication parameter of the set of communication parameters to display for each of the first network associated with the first SIM card and the second communication network associated with the second SIM card may be maintained until the user changes the parameters to be displayed.

In another aspect, the apparatus may receive a communication request to initiate a first wireless communication with a contact of the plurality of contacts or to initiate a second wireless communication with a number that is not associated with the plurality of contacts. The apparatus may also display a first set of communication parameters associated with initiating one of the first wireless communication or the second wireless communication using a first communication network associated with the first SIM card and a second set of communication parameters associated with initiating the one of the first wireless communication or the second wireless communication using a second communication network associated with the second SIM card.

In another aspect, the apparatus may include a memory, and at least one processor coupled to the memory. The apparatus (e.g., the at least one processor of the apparatus) may be configured to receive a communication request to initiate a first wireless communication with a contact of the plurality of contacts or to initiate a second wireless communication with a number that is not associated with the plurality of contacts. The apparatus (e.g., the at least one processor of the apparatus) may also be configured to display a first set of communication parameters associated with initiating one of the first wireless communication or the second wireless communication using a first communication network associated with the first SIM card and a second set of communication parameters associated with initiating the one of the first wireless communication or the second wireless communication using a second communication network associated with the second SIM card.

In a further aspect, the apparatus may include means for receiving a communication request to initiate a first wireless communication with a contact of the plurality of contacts or to initiate a second wireless communication with a number that is not associated with the plurality of contacts. The apparatus may also include means for displaying a first set of communication parameters associated with initiating one of the first wireless communication or the second wireless communication using a first communication network associated with the first SIM card and a second set of communication parameters associated with initiating the one of the first wireless communication or the second wireless communication using a second communication network associated with the second SIM card.

In another aspect, the apparatus may receive an initial request to initiate a wireless communication with a number that is not associated with a contact of the plurality of contacts. The apparatus may also display a set of communication parameters associated with initiating the wireless communication with the number that is not associated with a contact of the plurality of contacts using a first communication network associated with the first SIM card and a second communication network associated with the second SIM card. The apparatus may further receive a selection of at least one first communication parameter of the set of communication parameters to display for each of the first communication network associated with the first SIM card and the second communication network associated with the second SIM card. In addition, the apparatus may maintain the selection of the at least one first communication parameter of the set of communication parameters to display for each of the first communication network associated with the first SIM card and the second communication network associated with the second SIM card. In a further aspect, the apparatus may receive a subsequent request to initiate a subsequent wireless communication with the number. In another aspect, the apparatus may display the at least one first communication parameter of the set of communication parameters for each of the first communication network associated with the first SIM card and the second communication network associated with the second SIM card when the subsequent request to initiate the subsequent wireless communication with the number is received.

In a further aspect, the apparatus include a memory, and at least one processor coupled to the memory. The apparatus (e.g., the at least one processor of the apparatus) may be configured to receive an initial request to initiate a wireless communication with a number that is not associated with a contact of the plurality of contacts. The apparatus (e.g., the at least one processor of the apparatus) may also be configured to display a set of communication parameters associated with initiating the wireless communication with the number that is not associated with a contact of the plurality of contacts using a first communication network associated with the first SIM card and a second communication network associated with the second SIM card. The apparatus (e.g., the at least one processor of the apparatus) may further be configured to receive a selection of at least one first communication parameter of the set of communication parameters to display for each of the first communication network associated with the first SIM card and the second communication network associated with the second SIM card. In addition, the apparatus (e.g., the at least one processor of the apparatus) may be configured to maintain the selection of the at least one first communication parameter of the set of communication parameters to display for each of the first communication network associated with the first SIM card and the second communication network associated with the second SIM card. In a further aspect, the apparatus (e.g., the at least one processor of the apparatus) may be configured to receive a subsequent request to initiate a subsequent wireless communication with the number. In another aspect, the apparatus (e.g., the at least one processor of the apparatus) may be configured to display the at least one first communication parameter of the set of communication parameters for each of the first communication network associated with the first SIM card and the second communication network associated with the second SIM card when the subsequent request to initiate the subsequent wireless communication with the number is received.

In a further aspect, the apparatus include may means for receiving an initial request to initiate a wireless communication with a number that is not associated with a contact of the plurality of contacts. The apparatus may also include means for displaying a set of communication parameters associated with initiating the wireless communication with the number that is not associated with a contact of the plurality of contacts using a first communication network associated with the first SIM card and a second communication network associated with the second SIM card. The apparatus may further include means for receiving a selection of at least one first communication parameter of the set of communication parameters to display for each of the first communication network associated with the first SIM card and the second communication network associated with the second SIM card. In addition, the apparatus may further include means for maintaining the selection of the at least one first communication parameter of the set of communication parameters to display for each of the first communication network associated with the first SIM card and the second communication network associated with the second SIM card. In a further aspect, the apparatus may further include means for receiving a subsequent request to initiate a subsequent wireless communication with the number. In another aspect, the apparatus may include means for displaying the at least one first communication parameter of the set of communication parameters for each of the first communication network associated with the first SIM card and the second communication network associated with the second SIM card when the subsequent request to initiate the subsequent wireless communication with the number is received.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example multi-SIM card UE displaying communication settings that may be selected and/or updated in accordance with certain aspects of the disclosure.

FIG. 1B is a diagram illustrating an example multi-SIM card UE displaying SIM selection settings that may be selected and/or updated in accordance with certain aspects of the disclosure.

FIG. 1C is a diagram illustrating an example multi-SIM card UE displaying a contact list in accordance with certain aspects of the disclosure.

FIG. 1D is a diagram illustrating an example multi-SIM card UE displaying the SIM selection settings selected and/or updated in FIG. 1B in accordance with certain aspects of the disclosure.

FIGS. 2A and 2B are a flowchart of a method of displaying SIM selection settings that may be selected and/or updated in accordance with certain aspects of the disclosure.

FIG. 3 is a conceptual data flow diagram illustrating the data flow between different means/components in an exemplary apparatus.

FIG. 4 is a diagram illustrating an example of a hardware implementation for an apparatus employing a processing system.

FIG. 5 is a flowchart of a method of displaying SIM selection settings in accordance with certain aspects of the disclosure.

FIG. 6 is a conceptual data flow diagram illustrating the data flow between different means/components in an exemplary apparatus.

FIG. 7 is a diagram illustrating an example of a hardware implementation for an apparatus employing a processing system.

FIGS. 8A and 8B are a flowchart of a method of displaying SIM selection settings in accordance with certain aspects of the disclosure

FIG. 9 is a conceptual data flow diagram illustrating the data flow between different means/components in an exemplary apparatus.

FIG. 10 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of UEs will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

With a multi-SIM card UE, a user may send and/or receive wireless communications using any of the phone numbers associated with the multiple SIM cards maintained at the UE. For example, a user may be able to send and/or receive wireless communications associated with a work mobile number and a personal mobile number using the same device. When a user wants to initiate a wireless communication (e.g., mobile voice communication, wireless data communication, wireless text message, wireless video communication, etc.), the user may not have visibility of certain communication parameters that the user may want to consider before choosing a mobile number to initiate a wireless communication.

In a first configuration, a multi-SIM card UE may be configured such that one of the multiple SIM cards is preferred and used to initiate a wireless communication (e.g., voice call, text message, video call, etc.) when a request for the wireless communication is received. For example, in a settings option on the multi-SIM card UE, a user may configure which SIM card is used (e.g., ‘SIM 1 always’ or ‘SIM 2 always’) whenever a user initiates a wireless communication. In other words, a pop-up box requesting a selection of one of the SIM cards may not be displayed, and the preferred SIM card enabled in the settings option may be used to initiate the wireless communication.

One limitation associated with the first configuration may be that all the mobile numbers (e.g., a first mobile number associated with SIM 1 and a second mobile number associated with SIM 2) associated with the different SIM cards may not be shared with all contacts maintained by the multi-SIM card UE. Hence, the user may want to initiate a wireless communication with a contact only using the mobile number previously shared with the contact. However, if SIM 1 is configured (e.g., in the settings option) to initiate all wireless communications, and only the mobile number for SIM 2 has been shared with the contact, the user may want to initiate a wireless communication with the contact using SIM 2 and not SIM 1. Hence, the mobile number (e.g., associated with SIM 1) that the user wants to keep private may be inadvertently shared with the contact.

In a second configuration, a multi-SIM card UE may be configured such that the user is prompted to choose which SIM card is used to initiate wireless communications. For example, in a settings option on the multi-SIM card UE, a user may configure an ‘prompt’ setting such that each time a user initiates a wireless communication, a prompt (e.g. pop-up box) requesting a selection of one of the SIM cards appears.

One limitation associated with the second configuration may be that when the user receives the prompt to select a SIM card to initiate a wireless communication, the user may not have visibility of settings for certain communication parameters that may enable the user to make an informed decision with respect to which SIM card to use. For example, the user may not have visibility of the expected communication cost to the destination number when selecting a SIM card, whether the contact the first mobile number associated with a first SIM card or the second mobile number associated with a second SIM card, signal quality, etc. Hence, the user may select a SIM card to initiate a wireless communication that results a higher call cost, a weaker signal connection, etc.

In a third configuration, a multi-SIM card UE may be configured such that SIM card selection is based on a single call parameter (e.g., call cost). For example, in a settings option on the multi-SIM card UE, a user may configure an automatic SIM card selection based on call cost. In other words, the SIM card associated with the lowest call cost is selected to initiate a wireless communication.

One limitation associated with the third configuration may be that the SIM card associated with the lowest call cost may not be the optimal and best choice in all scenarios. For example, when a user is trying to communicate with a contact to pass on a short but urgent information and/or message, the user may want to select a SIM card (e.g., the subscriber associated with the SIM card) with the best signal quality rather than the SIM card with lower cost. Another limitation associated with the third configuration may be that in scenarios in which the user is trying to call a friend for a regular chat that is expected to last for a long duration, the user may want to initiate the wireless communication using the SIM card that will provide the lowest cost based on the network operator of the destination number or based on the current balance on each of the SIM cards. A further limitation associated with the third configuration may be that when initiating a wireless communication with a contact, the user may not want to reveal a mobile phone number associated with another SIM with the contact, and hence may want to only use the SIM card whose associated number is previously shared with the contact irrespective of any other call parameters.

There is a need to provide visibility to communication parameters before initiating wireless communication using a mobile number maintained at a multi-SIM UE.

The present disclosure provides a solution to the limited visibility of communication parameters by maintaining a selection of at least one first communication parameter of a set of communication parameters, and displaying the at least one first communication parameter for each of a first network associated with a first SIM card and a second communication network associated with a second SIM card when a wireless communication request is initiated at the multi-SIM card UE.

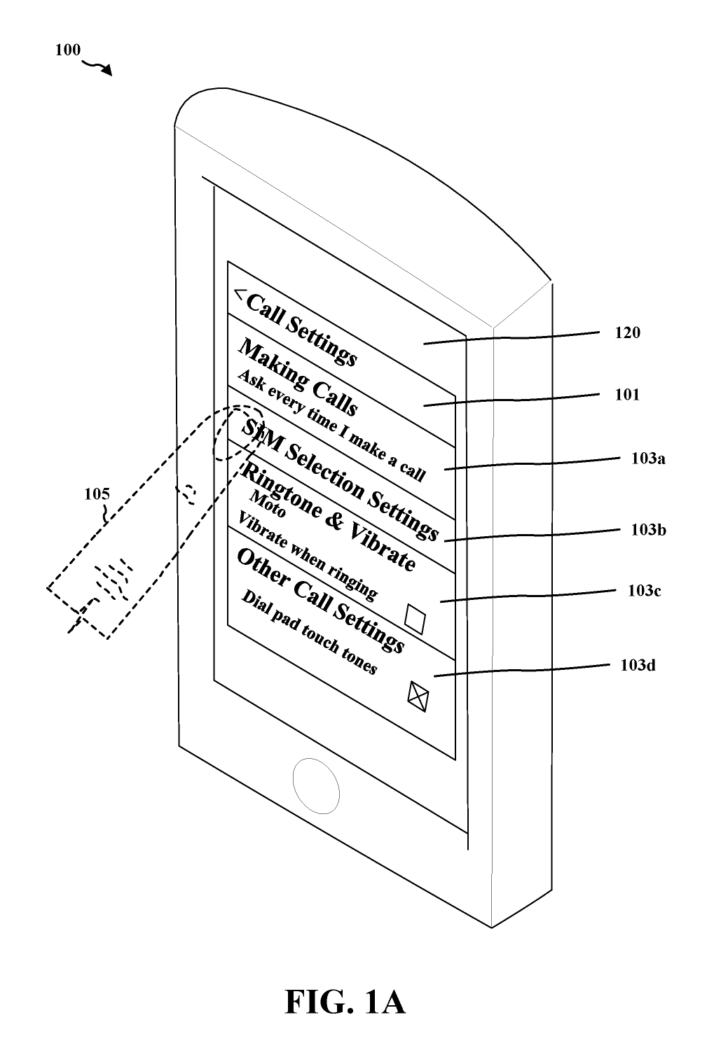

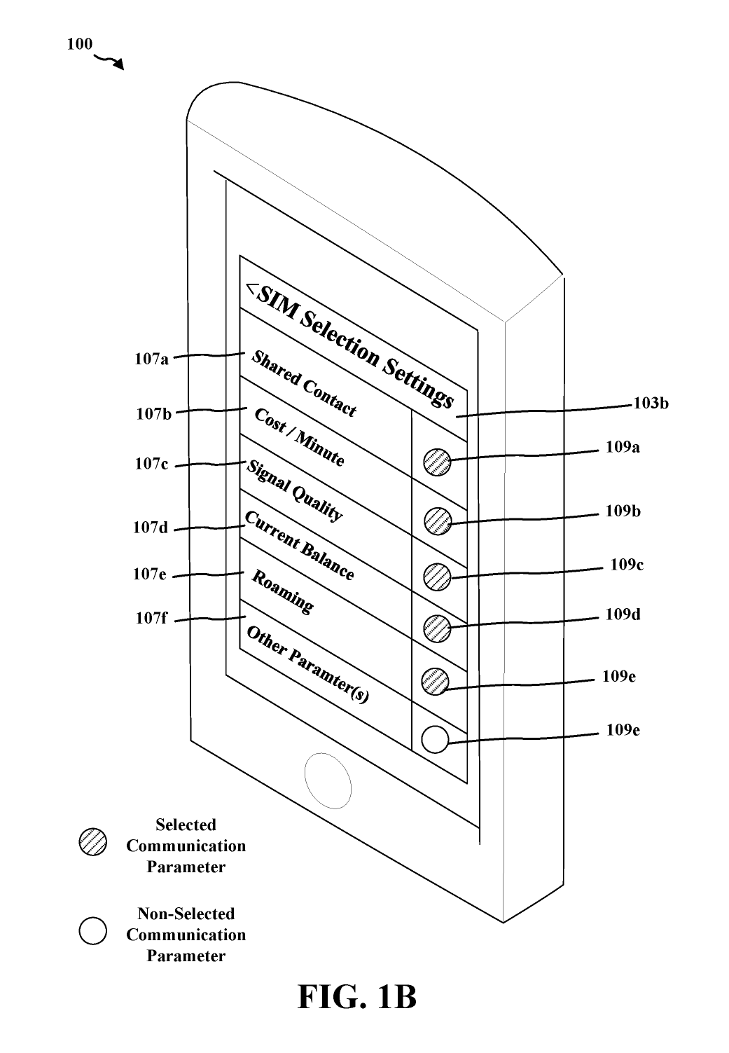

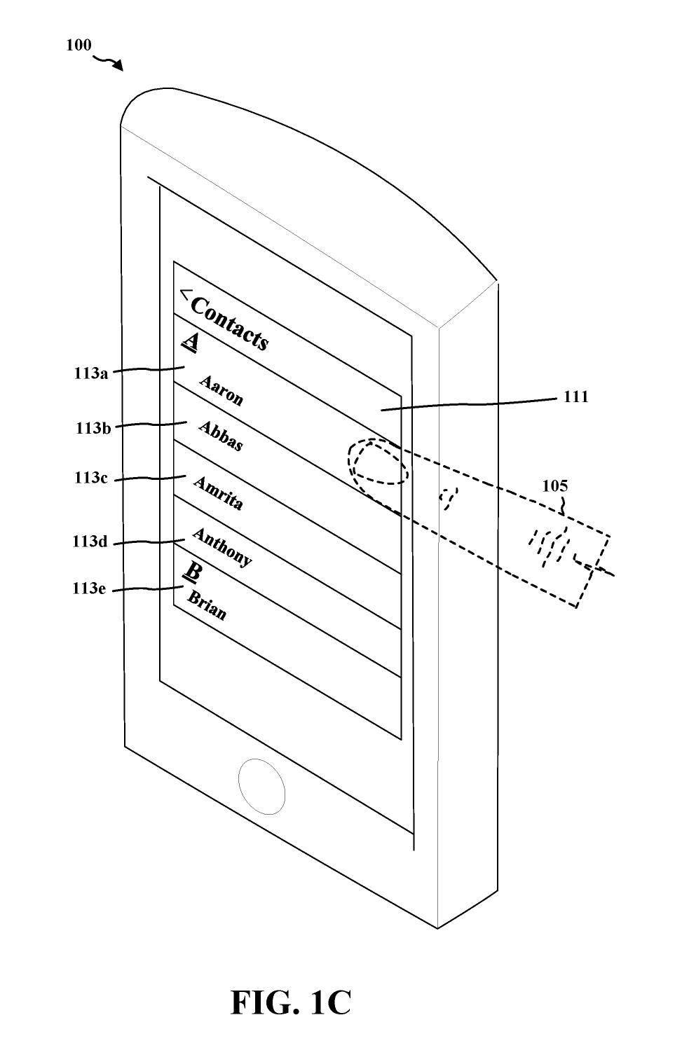

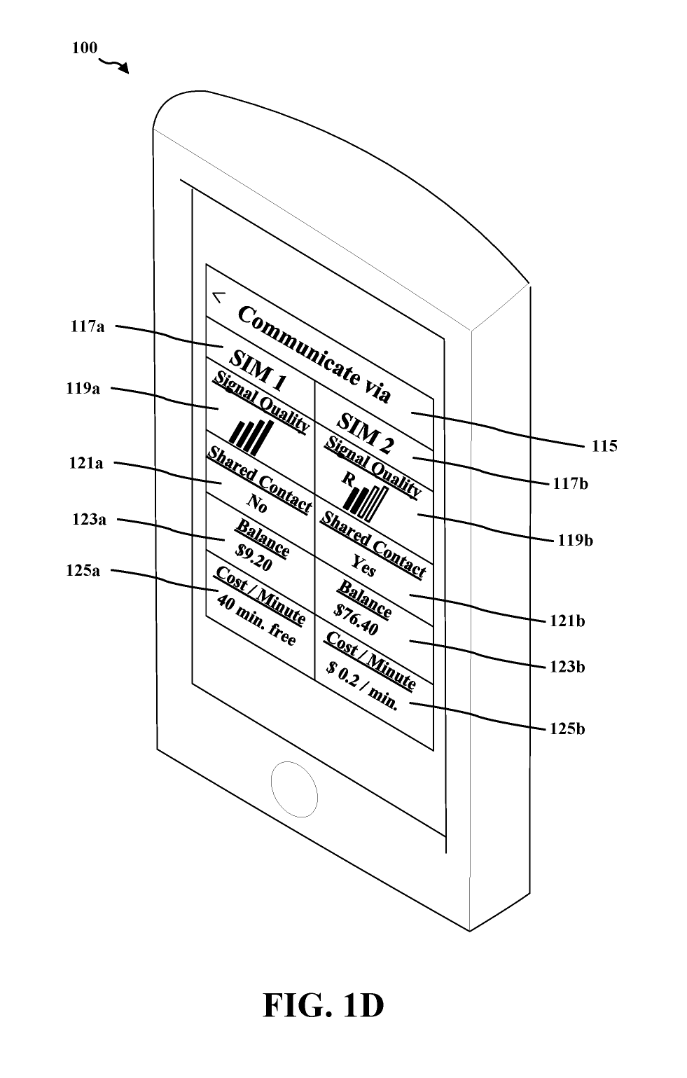

FIGS. 1A-1D illustrate an example embodiment of a UE 100 (e.g., a multi-SIM card UE) that may be configured to maintain a selection of at least one first communication parameter of a set of communication parameters for each of a first network associated with a first SIM card and a second communication network associated with a second SIM card. In addition, the UE 100 illustrated in FIGS. 1A-1D may display the selection of at least one first communication parameter of a set of communication parameters when a request to initiate a wireless communication is received. Although two SIM cards are described below with respect to FIGS. 1A-1D, more than two SIM cards may be included in the UE 100 without departing from the scope of the present invention. For example, if the UE 100 includes three SIM cards then the UE 100 may maintain a selection of at least one first communication parameter of a set of communication parameters for each of a first network associated with a first SIM card, a second communication network associated with a second SIM card, and a third communication network associated with a third SIM card. The UE 100 may include, e.g., the apparatus 302/302′, 602/602′, and/or 902/902′.

In one aspect, the user may select one or more communication parameters from a set of communication parameters that may be displayed when a request to initiate a wireless communication is received. For example, the user may launch a control panel and/or settings panel on the UE 100 that allows the user to view and manipulate basic system settings and controls, such as selecting and/or updating communication parameters, as described infra. In addition, the UE 100 may store and/or have access to a subset of contacts that are associated with a subset of the one or more communication parameters such that when a communication request is received for one of the contacts in the subset of contacts, the subset of the communication parameters associated with that contact are displayed as described infra.

FIG. 1A illustrates UE 100 displaying a call settings panel 101 on a display screen 120 in accordance with certain aspects of the present disclosure. For example, the call settings panel 101 may include a list of various call settings and/or communication settings that may be selected, updated, and/or manipulated by a user. The various call settings may be selected, updated, and/or manipulated when the user interacts (e.g., contacts, taps, touches, depresses, swipes, etc.) with the display screen 120 in a region associated with one of the call settings (e.g., using the user's finger 105). The call settings and/or communication settings displayed within the call settings panel 101 may include a ‘Making Calls’ panel 103a, a ‘SIM Selection Settings’ panel 103b, a ‘Ringtone & Vibrate’ panel 103c, and an ‘Other Call Settings’ panel 103d.

In the example illustrated in FIG. 1A, the ‘Making Calls’ panel 103a may enable the user to select how frequently the communication parameters (e.g., illustrated in FIG. 1D) are displayed. In the particular example illustrated in FIG. 1A, the UE 100 is configured such that the communication parameters may be displayed before all calls and/or communications are initiated. In one configuration, the ‘Making Calls’ panel 103a may enable the user to select how frequently the list of communication parameters (e.g., illustrated in FIG. 1B) is displayed. For example, the user may select to have the list of communication parameters illustrated in FIG. 1B displayed each time a request to initiate a communication is received at the UE 100. In other words, the user may select which communication parameters to display before each communication is initiated.

In addition, when the user touches, swipes, and/or interacts with the ‘SIM Selection Settings’ panel 103b, a list of the communication parameters may be displayed, as illustrated in FIG. 1B.

The ‘Ringtone & Vibrate’ panel 103c may enable a user to select and/or update a ringtone that is emitted when a call and/or other communication is received at the UE 100. In the example illustrated in FIG. 1A, the user has selected ‘Moto’ as the particular ringtone. In addition, ‘Ringtone & Vibrate’ panel 103c may enable a user to select whether the UE 100 vibrates when an incoming communication (e.g., call, text, email, video call, etc.) is received. In the particular example illustrated in FIG. 1A, the user has not selected to have the UE 100 vibrate when an incoming communication is received.

The ‘Other Call Settings’ panel 103d may enable a user to select and/or update whether dial pad touch tones are emitted when a user types in a number to call and/or communicate with, a contact name to call and/or communicate with, and/or text. In the particular example, illustrated in FIG. 1A, the user has selected and/or chosen to have dial pad touch tones emitted when numbers and/or text are typed on the UE 100.

FIG. 1B illustrates the UE 100 displaying the ‘SIM Selection Settings’ panel 103b on the display screen 120 in accordance with certain aspects of the present disclosure. For example, the ‘SIM Selection Settings’ panel 103b may include a list of various communication parameters that may be configured for display. For example, the various communication parameters may be selected, updated, and/or manipulated by a user. Additionally and/or alternatively, the communication parameters may be automatically updated by the UE 100. For example, when a prepaid balance associated with a SIM card drops below a threshold amount, the UE 100 may automatically update the communication parameters to include display prepaid balance information if prepaid balance information is not already configured for display. In addition, the communication parameters selected by the user may be displayed (e.g., see FIG. 1D) when a request to initiate a wireless communication is received at the UE 100. In certain aspects, the list of communication parameters may be displayed when the user touches, swipes, interacts with (e.g., physical interaction, voice command, etc.) the ‘SIM Selection Settings’ panel 103b displayed in the Call Settings panel 101 illustrated in FIG. 1A.

The various communication parameters displayed within the ‘SIM Selection Settings’ panel 103b illustrated in FIG. 1B may include a ‘Shared Contact’ parameter 107a, a ‘Call Cost’ parameter 107b, a ‘Signal Quality’ parameter 107c, a ‘Current Balance’ parameter 107d, a ‘Roaming’ parameter 107e, and/or ‘Other Parameter(s)’ 107f In addition, each of the communication parameters 107a, 107b, 107c, 107d, 107e, and 107f may have a respective selection region 109a, 109b, 109c, 109d, 109e, and 109f For example, a selective region may include an on/off toggle that may be selected on to have the respective communication parameter displayed before initiating a wireless communication. The communication parameters 107a, 107b, 107c, 107d, 107e, and 107f illustrated in FIG. 1B is intended to be illustrative only, and different combinations of communication parameters may be displayed without departing from the scope of the present disclosure.

In one aspect, selecting the ‘Shared Contact’ parameter 107a may provide the user with an indication of whether a mobile number associated with each of the SIM cards in the UE 100 (e.g., multi-SIM card UE) was previously used for at least one previous wireless communication with the contact with whom the user is trying to communicate.

In another aspect, selecting the ‘Call Cost’ parameter 107b may provide the user with an indication of the cost per time unit (e.g., second, minute, hour, etc.) associated with initiating a wireless communication using each of the SIM cards in the UE 100.

In a further aspect, selecting the ‘Signal Quality’ parameter 107c may provide the user with an indication of a signal strength for each wireless communication network associated with each of the SIM cards in the UE 100.

In another aspect, selecting the ‘Current Balance’ parameter 107d may provide the user with an indication of a prepaid balance and/or available free minutes associated with each of the SIM cards in the UE 100.

In a further aspect, selecting the ‘Roaming’ parameter 107e may provide the user with an indication of roaming information associated with initiating a wireless communication using each of the SIM cards in the UE 100.

In yet another aspect, selecting the ‘Other Parameter(s)’ 107f may provide the user with an indication of any other type of communication parameters known in the art.

In the example illustrated in FIG. 1B, the ‘Shared Contact’ parameter 107a, the ‘Call Cost’ parameter 107b, the ‘Signal Quality’ parameter 107c, the ‘Current Balance’ parameter 107d, and the ‘Roaming’ parameter 107e are configured to be displayed prior to initiating wireless communications as indicated by the respective shaded selection regions 109a, 109b, 109c, 109d, and 109e. The UE 100 may maintain a list of the selected communication parameters using a RAM, a ROM, an EEPROM, optical disk storage, magnetic disk storage, other magnetic storage devices, and/or one or more external servers and/or databases. Further, the ‘Other Parameter(s)’ 107f is not selected for display before initiating wireless communications as indicated by the non-shaded selection region 109f.

In one configuration, a user may select a first subset of the communication parameters discussed supra to be associated with a first subset of contacts (e.g., work contacts) and a second subset of the communication parameters discussed supra to be associated with the second subset of contacts (e.g., non-work contacts). In one configuration, the first subset of the communication parameters and the second subset of the communication parameters may include the same subset of communication parameters. In another configuration, the first subset of the communication parameters and the second subset of the communication parameters may include a different subset of communication parameters.

FIG. 1C illustrates the UE 100 displaying a contact list 111 in accordance with certain aspects of the present disclosure. For example, the contact list 111 may include a list of contacts maintained by the UE 100. In the example illustrated in FIG. 1C, the contacts visible in the contact list 111 may include Aaron 113a, Abbas 113b, Amrita 113c, Anthony 113d, and Brian 113e. In addition, the user (e.g. using the user's finger 105, voice command selection, etc.) may choose to initiate a communication with Aaron 113a. For example, the user may choose to initiate a wireless communication with one of the contacts in the contact list 111 by interacting (e.g., contacts, taps, touches, depresses, swipes, etc.) with a region associated with a particular contact (e.g., the region being the displayed contact's name). The communication parameters selected configured in FIG. 1B may be displayed prior to initiating the communication with a selected contact as illustrated in FIG. 1D.

Additionally and/or alternatively, the user may select a first subset of contacts to be associated with a first subset of the communication parameters selected in FIG. 1B and a second subset of contacts associated with a second subset of communication parameters illustrated in FIG. 1B.

For example, the user may select Aaron 113a and Abbas 113b to be associated with the ‘Shared Contact’ parameter 107a, the ‘Call Cost’ parameter 107b, the ‘Signal Quality’ parameter 107c, the ‘Current Balance’ parameter 107d, and the ‘Roaming’ parameter 107e illustrated in FIG. 1B. In other words, when the user wants to communicate with either Aaron 113a and/or Abbas 113b (e.g., work contacts), information associated with whether the contact is shared for a particular SIM, the call cost, the signal quality, the current balance, and roaming parameters for each of the SIM cards at the UE 100 may be displayed. However, the user may only want to associate the ‘Call Cost’ parameter 107b and the ‘Signal Quality’ parameter 107c with Amrita 113c and Anthony 113d (e.g., non-work contacts). Thus, information associated with the call cost and the signal quality may be displayed before a wireless communication with either Amrita 113c or Anthony 113d is initiated. The UE 100 may maintain a list of the subset(s) of contacts and the respected selected communication parameters using a RAM, a ROM, an EEPROM, optical disk storage, magnetic disk storage, other magnetic storage devices, and/or one or more external servers and/or databases.

In one configuration, when the UE 100 receives a request to initiate an initial communication with a number that is not associated with a contact in the contact list 111 accessible to the UE 100, the list of various communication parameters in the ‘SIM Selection Settings’ panel 103b (e.g., discussed supra with respect to FIG. 1B) may be displayed prior to initiating the initial communication. The UE 100 may receive a selection (e.g., from the user) of communication parameters from the list of displayed communication parameters in the ‘SIM Selection Settings’ panel 103b, and display the communication parameters for each of the first SIM card and the second SIM card. In addition, the UE 100 may maintain the selection of the communication parameters to display before initiating a communication with the number. Hence, when the UE 100 receives a subsequent request to initiate a subsequent communication with the number, the UE 100 may display the selected communication parameters (e.g., see FIG. 1D) that were selected before the initial communication without displaying the list of various communication parameters in the ‘SIM Selection Settings’ panel 103b for selection by the user.

FIG. 1D illustrates the UE 100 displaying the communication parameters selected in FIG. 1B in accordance with certain aspects of the present disclosure. Based on the communication parameters displayed for each of SIM 1 and SIM 2, the user may choose to initiate the wireless communication by touching, swiping, and/or interacting with either SIM 1 region 117a (e.g., to initiate a communication using SIM 1) or SIM 2 region 117b (e.g., to initiate a communication using SIM 2) displayed under the ‘Communicate via’ panel 115. For example, a ‘Signal Quality’ region 119a, 119b, a ‘Shared Contact’ region 121a, 121b, a ‘Current Balance’ region 123a, 123b, and a ‘Call Cost’ region 125a, 125b for each of SIM and SIM 2 may display information associated with the communication parameters selected in FIG. 1B.

In the example illustrated in FIG. 1D, the ‘Signal Quality’ region 119a associated with SIM 1 indicates that SIM 1 may communicate with full signal strength (e.g., as indicated by all of the signal strength bars being shaded) and without roaming (e.g., as indicated by an absence of roaming symbol ‘R’). However, the ‘Signal Quality’ region 119b associated with SIM 2 indicates that SIM 2 may communicate with partial signal strength (e.g., as indicated by only two of the four signal strength bars being shaded). In addition, the ‘Signal Quality’ region 119b associated with SIM 2 indicates that the UE 100 is outside of a coverage area for the wireless communication network associated with SIM 2, and hence roaming (e.g., e.g., as indicated by the presence of roaming symbol ‘R’).

As also depicted in the example illustrated in FIG. 1D, the ‘Shared Contact’ region 121a associated with SIM 1 indicates that the mobile number associated with SIM 1 has not been shared with the contact with whom the user wants to initiate a wireless communication. Further, the ‘Shared Contact’ region 121b associated with SIM 2 indicates that the mobile number associated with SIM 2 has been shared with the contact with whom the user wants to initiate a wireless communication. In one aspect, the UE 100 may determine if a mobile number associated with a particular SIM card has been shared with a contact by tagging the stored contact against a preferred SIM card while storing the contact and/or based on an understanding of which number is shared with that contact. In one aspect, the tag may include a value that indicates which SIM card a particular contact is associated with. For example, a value of ‘1’ associated with a first contact may indicate that the first contact is associated with SIM 1, and a value of ‘2’ associated with a second contact may indicate that the second contact is associated with SIM 2. In another configuration, the UE 100 may maintain a look up table that indicates which contacts are associated with which SIM cards. Additionally and/or alternatively, the UE 100 may determine whether a mobile number associated with a SIM card has been shared with a contact may be based on incoming communication history such that if the UE 100 receives a communication from User ‘A’ on the mobile number associated with SIM 1, the UE 100 may automatically mark SIM 1 as preferred for User ‘A’ contact information. If the incoming communication history indicates that the UE 100 receives communications from User ‘A’ a first mobile number associated with SIM 1 and a second mobile number associated with SIM 2, the UE 100 may automatically mark the SIM card of the mobile most recently used in the communication history as preferred SIM card to use for communications with User ‘A’.

As further depicted in the example illustrated in FIG. 1D, the ‘Current Balance’ region 123a indicates that the prepaid balance associated with SIM 1 is $9.20 while the ‘Current Balance’ region 123b indicates that the prepaid balance associated with SIM 2 is $76.40. For example, the UE 100 may determine the current balance for each SIM card by running an associated operator specified unique number for the operator associated with each SIM card to determine the current balance for each SIM card.

As additionally depicted in the example illustrated in FIG. 1D, the ‘Call Cost’ region 125a indicates that there are 40 free minutes (e.g., promotional minutes) available for use with the wireless communication network associated with SIM 1, and that the cost per minute associated with a wireless communication (e.g., voice call, video call, etc.) using SIM 2 is $0.2 per minute. For example, the UE 100 may determine a call cost based on a stored look-up where an entry of an estimated call cost from the operator of each SIM card in the UE 100 may be compared to all other possible operators of different SIM cards at the UE 100. The operator of the contact's number may then identified to determine the estimated per unit call cost to the contact.

Based on the communication parameters displayed in each of the ‘Signal Quality’ regions 119a, 119b, the ‘Shared Contact’ regions 121a, 121b, the ‘Current Balance’ regions 123a, 123b, and the ‘Call Cost’ regions 125a, 125b for each of SIM and SIM 2, the user may be enabled to make an informed selection with respect to which SIM card (e.g., SIM 1 or SIM 2) to use for communicating with a contact.

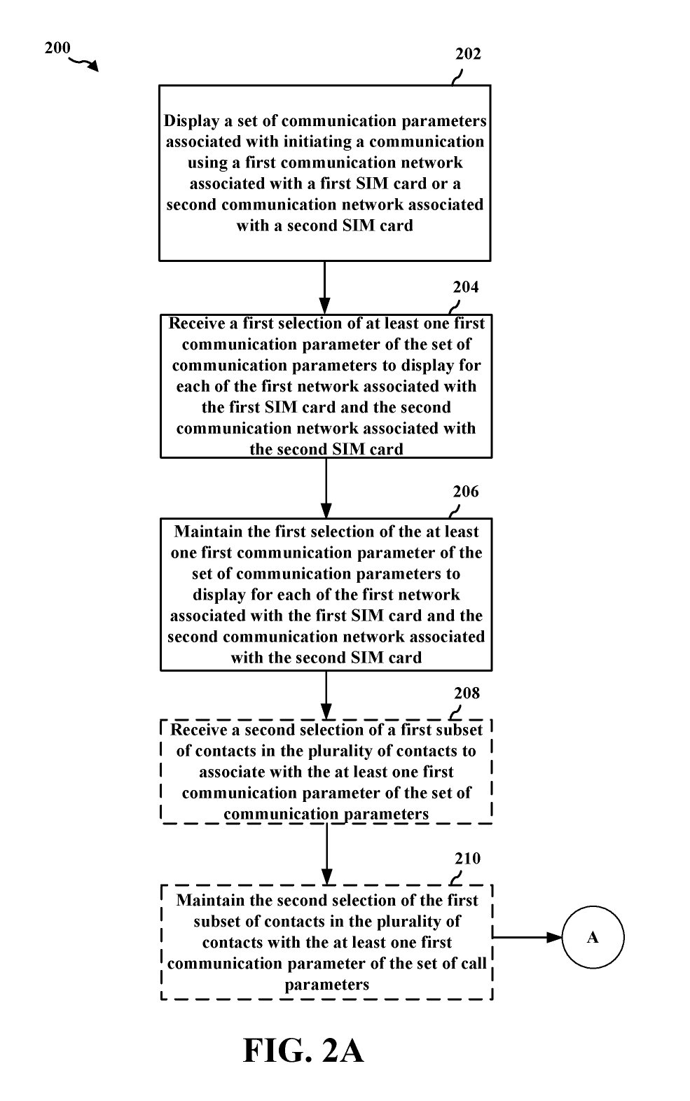

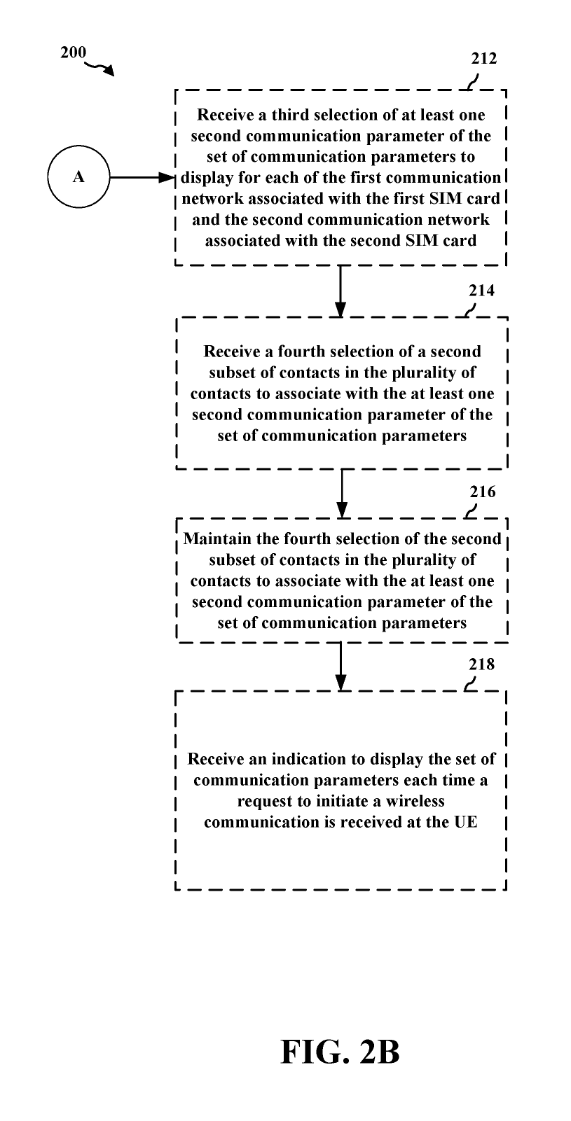

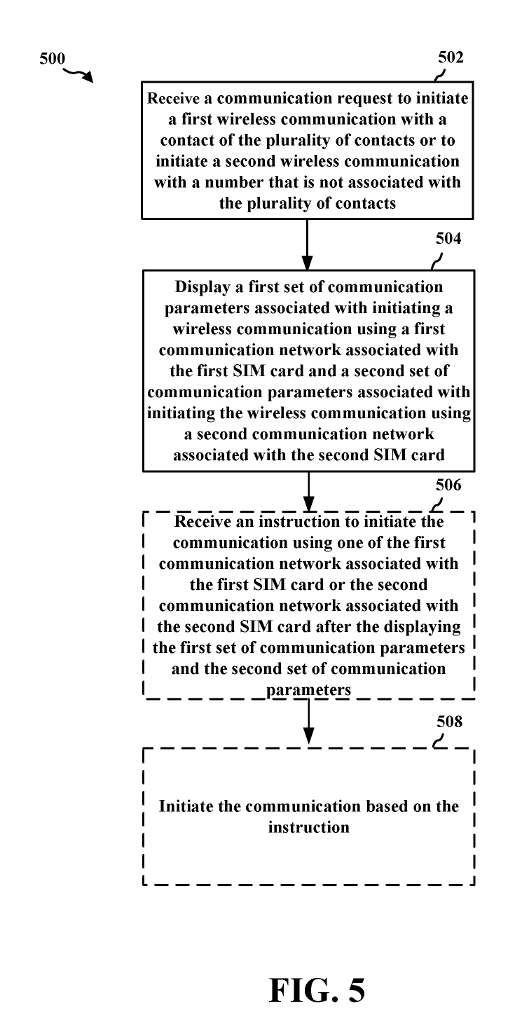

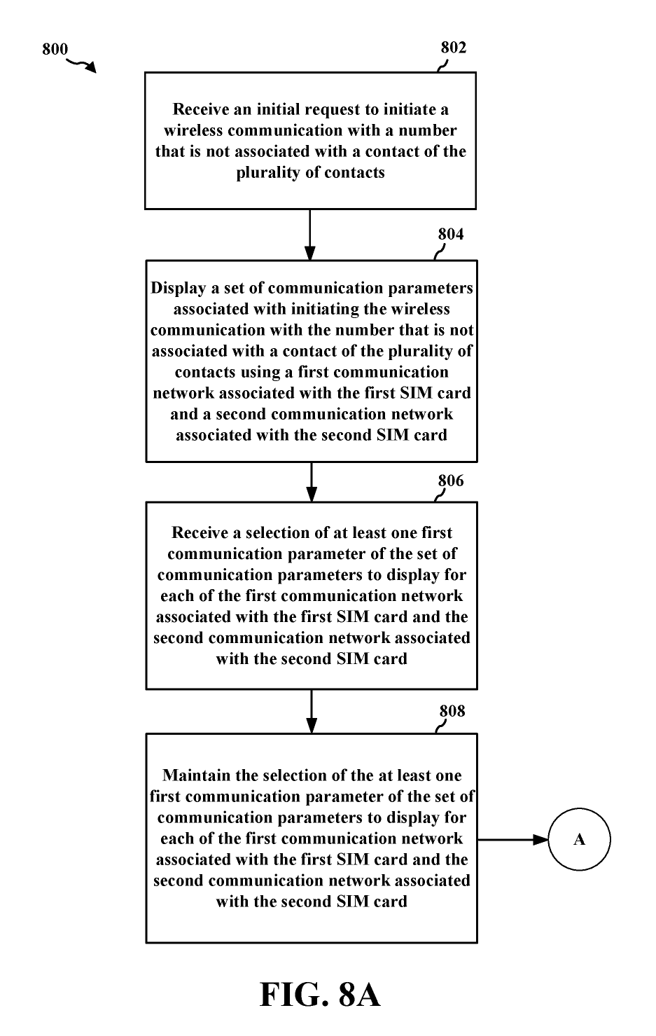

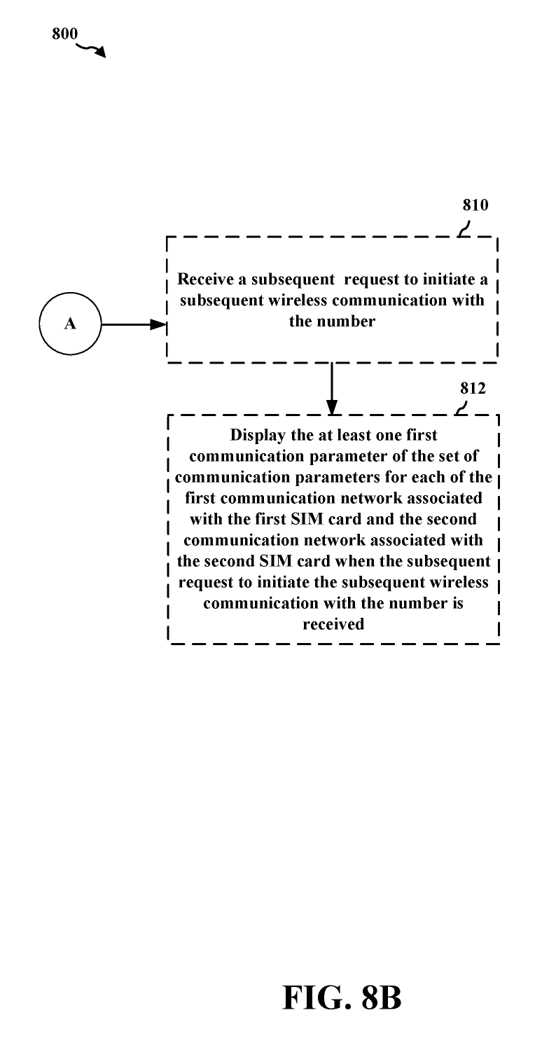

FIGS. 2A and 2B are a flowchart 200 of a method communication parameter selection for a multi-SIM UE in accordance with certain aspects of the disclosure. The method may be performed by a UE (e.g., the UE 100, the apparatus 302/302′, 602/602′, 902/902′). In FIGS. 2A and 2B, operations indicated with dashed lines may represent optional operations for various aspects of the disclosure. In certain configurations, the operations illustrated in FIGS. 2A and 2B may depend from one or more of the operations described infra with respect to FIG. 5 and/or FIGS. 8A and 8B.

As seen in FIG. 2A, at 202, the UE may display a set of call parameters associated with initiating a call using a first communication network associated with a first SIM card or a second communication network associated with a second SIM card. For example, referring to FIG. 1B, various communication parameters displayed within the ‘SIM Selection Settings’ panel 103b illustrated in FIG. 1B may include a ‘Shared Contact’ parameter 107a, a ‘Call Cost’ parameter 107b, a ‘Signal Quality’ 107c parameter, a ‘Current Balance’ parameter 107d, a ‘Roaming’ parameter 107e, and/or ‘Other Parameter(s)’ 107f. In addition, each of the communication parameters 107a, 107b, 107c, 107d, 107e, and 107f may have a respective selection region 109a, 109b, 109c, 109d, 109e, and 109f associated therewith. The communication parameters 107a, 107b, 107c, 107d, 107e, and 107f illustrated in FIG. 1B is intended to be illustrative only, and different combinations of communication parameters may be displayed without departing from the scope of the present disclosure.

At 204, the UE may receive a first selection of at least one first call parameter of the set of call parameters to display for each of the first network associated with the first SIM card and the second communication network associated with the second SIM card. For example, referring to FIG. 1B, the ‘SIM Selection Settings’ panel 103b may include a list of various communication parameters that may be selected, updated, and/or manipulated by a user. In addition, the communication parameters selected by the user may be displayed (e.g., see FIG. 1D) when a request to initiate a wireless communication is received at the UE 100.

At 206, the UE may maintain the first selection of the at least one first call parameter of the set of call parameters to display for each of the first network associated with the first SIM card and the second communication network associated with the second SIM card. For example, referring to FIG. 1B, UE 100 may maintain a list of the selected communication parameters using a RAM, a ROM, an EEPROM, optical disk storage, magnetic disk storage, other magnetic storage devices, and/or one or more external servers and/or databases. In certain aspects, the first selection of the at least one first communication parameter of the set of communication parameters to display for each of the first network associated with the first SIM card and the second communication network associated with the second SIM card may be maintained until the user changes and/or reconfigures the communication parameters to be displayed, or until the UE 100 automatically updates and/or reconfigures the communication parameters to be displayed.

At 208, the UE may receive a second selection of a first subset of contacts in the plurality of contacts to associate with the at least one first call parameter of the set of call parameters. In one aspect, the at least one first communication parameter for the first network associated with the first SIM card and the second communication network for the second SIM card may be displayed when a communication request for a contact in the first subset of contacts is received. For example, referring to FIGS. 1B and 1C, a user may select a first subset of the communication parameters discussed supra to be associated with a first subset of contacts (e.g., work contacts) and a second subset of the communication parameters discussed supra to be associated with the second subset of contacts (e.g., non-work contacts). In one aspect, the user may select a first subset of contacts (e.g., Aaron 113a and Abbas 113b) to be associated with a first subset of the call parameters displayed in FIG. 1B and a second subset of contacts (e.g., Amrita 113c and Anthony 113d) associated with a second subset of call parameters in FIG. 1B. For example, the user may select Aaron 113a and Abbas 113b (e.g., work contacts) to be associated with the ‘Shared Contact’ parameter 107a, the ‘Call Cost’ parameter 107b, the ‘Signal Quality’ 107c parameter, the ‘Current Balance’ parameter 107d, and the ‘Roaming’ parameter 107e illustrated in FIG. 1B. In other words, when the user wants to communicate with either Aaron 113a and/or Abbas 113b (e.g., first subset of contacts), information associated with whether the contact is shared for a particular SIM, the call cost, the signal quality, the current balance, and roaming parameters for each of the SIM cards at the UE 100 may be displayed before the user selects with SIM card to use to initiate a communication with either Aaron 113a or Abbas 113b.

At 210, the UE may maintain the second selection of the first subset of contacts in the plurality of contacts to associate with the at least one first call parameter of the set of call parameters. For example, referring to FIG. 1C, the UE 100 may maintain a list of the subset(s) of contacts and the respected selected communication parameters using a RAM, a ROM, an EEPROM, optical disk storage, magnetic disk storage, other magnetic storage devices, and/or one or more external servers and/or databases.

As seen in FIG. 2B, at 212, the UE may receive a third selection of at least one second communication parameter of the set of communication parameters to display for each of the first communication network associated with the first SIM card and the second communication network associated with the second SIM card. For example, referring to FIG. 1B, the ‘SIM Selection Settings’ panel 103b may include a list of various communication parameters that may be selected, updated, and/or manipulated by a user. In addition, the communication parameters selected by the user may be displayed (e.g., see FIG. 1D) when a request to initiate a wireless communication is received at the UE 100. In one aspect, a user may select a first subset of the communication parameters discussed supra to be associated with a first subset of contacts (e.g., work contacts) and a second subset of the communication parameters discussed supra to be associated with the second subset of contacts (e.g., non-work contacts). In one configuration, the first subset of the communication parameters and the second subset of the communication parameters may include the same subset of communication parameters. In another configuration, the first subset of the communication parameters and the second subset of the communication parameters may include different subsets of the communication parameters.

At 214, the UE may receive a fourth selection of a second subset of contacts in the plurality of contacts to associate with the at least one second communication parameter of the set of communication parameters. For example, referring to FIGS. 1B and 1C, a user may select a first subset of the communication parameters discussed supra to be associated with a first subset of contacts (e.g., work contacts) and a second subset of the communication parameters discussed supra to be associated with the second subset of contacts (e.g., non-work contacts). In one aspect, the user may select a first subset of contacts (e.g., Aaron 113a and Abbas 113b) to be associated with a first subset of the call parameters displayed in FIG. 1B and a second subset of contacts (e.g., Amrita 113c and Anthony 113d) associated with a second subset of call parameters in FIG. 1B. For example, the user may only want to associate the ‘Call Cost’ parameter 107b and the ‘Signal Quality’ parameter 107c with Amrita 113c and Anthony 113d (e.g., non-work contacts), and hence select ‘Call Cost’ parameter 107b and the ‘Signal Quality’ parameter 107c to be displayed before initiation a communication with Amrita 113c or Anthony 113d. Thus, information associated with the call cost and the signal quality may be displayed before a wireless communication with either Amrita 113c or Anthony 113d is initiated.

At 216, the UE may maintain the fourth selection of the second subset of contacts in the plurality of contacts to associate with the at least one second communication parameter of the set of communication parameters. For example, referring to FIG. 1C, the UE 100 may maintain a list of the subset(s) of contacts and the respected selected communication parameters using a RAM, a ROM, an EEPROM, optical disk storage, magnetic disk storage, other magnetic storage devices, and/or one or more external servers and/or databases.

At 218, the UE may receive an indication to display the set of communication parameters each time a request to initiate a wireless communication is received at the UE. For example, referring to FIG. 1A, the ‘Making Calls’ panel 103a may enable the user to select how frequently the list of communication parameters (e.g., illustrated in FIG. 1B) are displayed. For example, the user may select to have the list of communication parameters illustrated in FIG. 1B displayed each time a request to initiate a communication is received at the UE 100. In other words, the user may select which communication parameters to display before each communication is initiated.

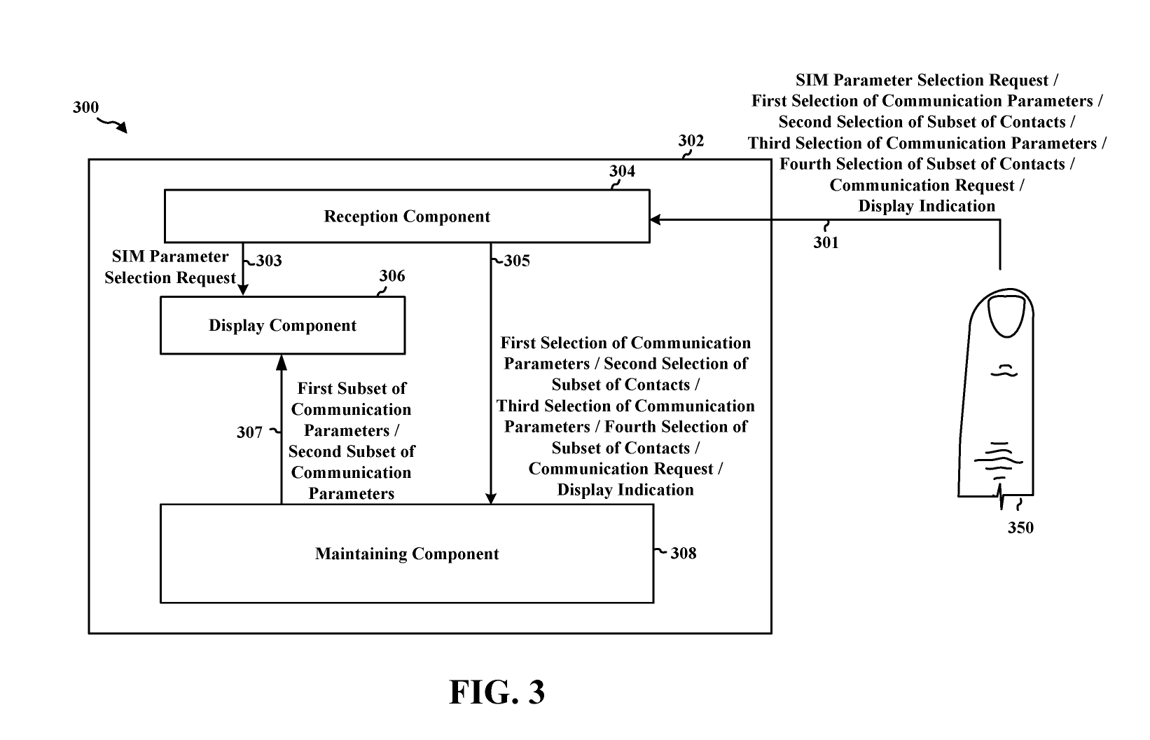

FIG. 3 is a conceptual data flow diagram 300 illustrating the data flow between different means/components in an exemplary apparatus 302. The apparatus may be a UE (e.g., UE 100, apparatus 302′, 602/602′, 902/902′) that receives selection information 301 from a user 350 (e.g., by user interaction with the apparatus 302). The apparatus may include a reception component 304 that is configured to receive a communication parameter display request 301. Reception component 304 may send a signal 303 associated with the communication parameter display request to display component 306. The display component 306 may be configured to display a set of communication parameters associated with initiating a communication using a first communication network associated with a first SIM card or a second communication network associated with a second SIM card. The apparatus may also include a reception component 304 that is configured to receive a first selection 301 of at least one first call parameter of the set of call parameters to display for each of the first network associated with the first SIM card and the second communication network associated with the second SIM card. The reception component 304 may send a signal 305 associated with the first selection of call parameters to a maintaining component 308. Maintaining component 308 may be configured to maintain the first selection of the at least one first communication parameter of the set of communication parameters to display for each of the first network associated with the first SIM card and the second communication network associated with the second SIM card. The reception component 304 may also be configured to receive a second selection of a first subset of contacts in the plurality of contacts to associate with the at least one first call parameter of the set of communication parameters. Reception component 304 may send a signal 305 associated with the second selection of a first subset of contacts to the maintaining component 308. In addition, the maintaining component 308 may be configured to maintain the second selection of the first subset of contacts in the plurality of contacts to associate with the at least one first communication parameter of the set of call parameters. Further, the reception component 304 may be configured to receive a third selection of at least one second communication parameter of the set of communication parameters to display for each of the first communication network associated with the first SIM card and the second communication network associated with the second SIM card. In addition, the reception component 304 may be configured to receive a fourth selection of a second subset of contacts in the plurality of contacts to associate with the at least one second communication parameter of the set of communication parameters. Reception component 304 may send a signal 305 associated with the third selection of the at least one second communication parameter of the set of communication parameters and/or the fourth selection of the second subset of contacts to the maintaining component 308. The maintaining component 308 may be configured to maintain the fourth selection of the second subset of contacts in the plurality of contacts to associate with the at least one second communication parameter of the set of communication parameters. The reception component 304 may be configured to receive an indication to display the set of communication parameters each time a request to initiate a wireless communication is received at the UE. Further, the reception component 304 may send a signal 305 associated with the indication to display the set of communication parameters each time a request to initiate a wireless communication is received at the UE. In addition, the reception component 304 may receive an indication to initiate a communication. The reception component 304 may send a signal 305 associated with the indication to initiate a communication to the maintaining component 308. The maintaining component 308 may send a signal associated with the subset of communication parameters, the second subset of communication parameters, and/or the set of communication parameters to the display component 306. The display component 306 may display the subset of communication parameters, the second subset of communication parameters, and/or the set of communication parameters depending on the signal received from the maintaining component 308 (e.g., also depending on which contact the user 350 requests to initiate a communication).

The apparatus may include additional components that perform each of the blocks of the algorithm in the aforementioned flowcharts of FIGS. 2A and 2B. As such, each block in the aforementioned flowcharts of FIGS. 2A and 2B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

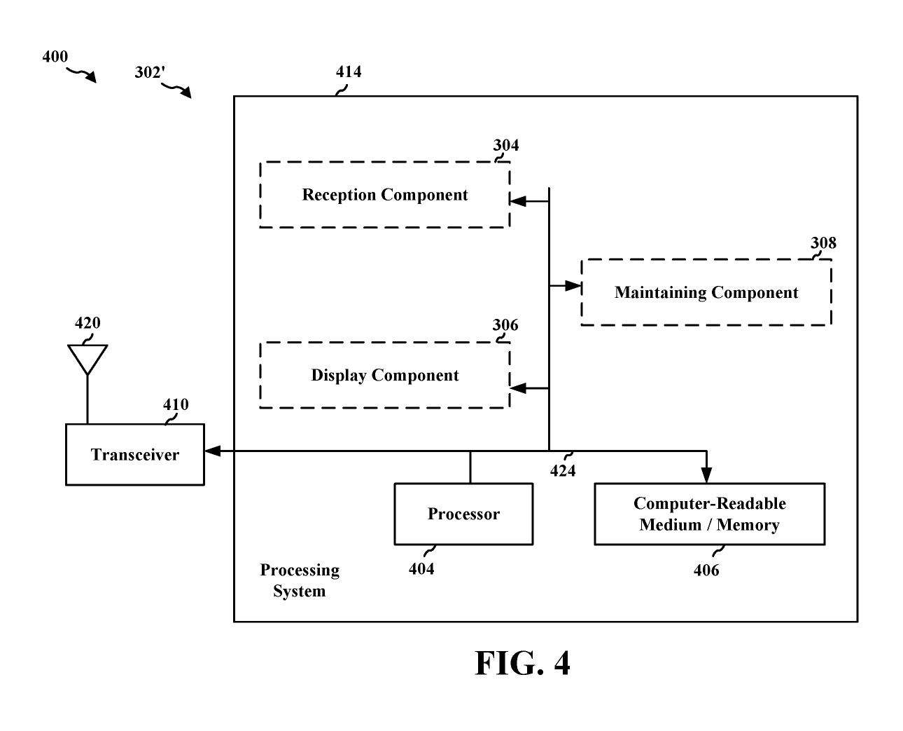

FIG. 4 is a diagram 400 illustrating an example of a hardware implementation for an apparatus 302′ employing a processing system 414. The processing system 414 may be implemented with a bus architecture, represented generally by the bus 424. The bus 424 may include any number of interconnecting buses and bridges depending on the specific application of the processing system 414 and the overall design constraints. The bus 424 links together various circuits including one or more processors and/or hardware components, represented by the processor 404, the components 304, 306, 308, and the computer-readable medium/memory 406. The bus 424 may also link various other circuits such as timing sources, peripherals, voltage regulators, and power management circuits, which are well known in the art, and therefore, will not be described any further.

The processing system 414 may be coupled to a transceiver 410. The transceiver 410 is coupled to one or more antennas 420. The transceiver 410 provides a means for communicating with various other apparatus over a transmission medium. The transceiver 410 receives a signal from the one or more antennas 420, extracts information from the received signal, and provides the extracted information to the processing system 414, specifically the reception component 304. In addition, the transceiver 410 receives information from the processing system 414, and based on the received information, generates a signal to be applied to the one or more antennas 420. The processing system 414 includes a processor 404 coupled to a computer-readable medium/memory 406. The processor 404 is responsible for general processing, including the execution of software stored on the computer-readable medium/memory 406. The software, when executed by the processor 404, causes the processing system 414 to perform the various functions described supra for any particular apparatus. The computer-readable medium/memory 406 may also be used for storing data that is manipulated by the processor 404 when executing software. The processing system 414 further includes at least one of the components 304, 306, 308. The components may be software components running in the processor 404, resident/stored in the computer readable medium/memory 406, one or more hardware components coupled to the processor 404, or some combination thereof.

In one configuration, the apparatus 302/302′ for wireless communication may include means for displaying a set of call parameters associated with initiating a call using a first communication network associated with a first SIM card or a second communication network associated with a second SIM card. In another configuration, the apparatus 302/302′ for wireless communication may include means for receiving a first selection of at least one first call parameter of the set of call parameters to display for each of the first network associated with the first SIM card and the second communication network associated with the second SIM card. In a further configuration, the apparatus 302/302′ for wireless communication may include means for maintaining the first selection of the at least one first call parameter of the set of call parameters to display for each of the first network associated with the first SIM card and the second communication network associated with the second SIM card. In one configuration, the apparatus 302/302′ for wireless communication may include means for receiving a second selection of a first subset of contacts in the plurality of contacts to associate with the at least one first call parameter of the set of call parameters. In one aspect, the at least one first communication parameter for the first network associated with the first SIM card and the second communication network for the second SIM card may be displayed when a communication request for a contact in the first subset of contacts is received. In another configuration, the apparatus 302/302′ for wireless communication may include means for maintaining the second selection of the first subset of contacts in the plurality of contacts to associate with the at least one first call parameter of the set of call parameters. In further configuration, the apparatus 302/302′ for wireless communication may include means for receiving a third selection of at least one second communication parameter of the set of communication parameters to display for each of the first communication network associated with the first SIM card and the second communication network associated with the second SIM card. In one configuration, the apparatus 302/302′ for wireless communication may include means for receiving a fourth selection of a second subset of contacts in the plurality of contacts to associate with the at least one second communication parameter of the set of communication parameters. In another configuration, the apparatus 302/302′ for wireless communication may include means for maintaining the fourth selection of the second subset of contacts in the plurality of contacts to associate with the at least one second communication parameter of the set of communication parameters. In a further aspect, the apparatus 302/302′ for wireless communication may include means for receiving an indication to display the at least one first communication parameter for each of the first communication network associated with the first SIM card and the second communication network associated with the second SIM card each time a request to initiate a wireless communication is received at the UE. The aforementioned means may be one or more of the aforementioned components of the apparatus 302 and/or the processing system 414 of the apparatus 302′ configured to perform the functions recited by the aforementioned means.

FIG. 5 is a flowchart 500 of a method communication parameter selection for a multi-SIM UE in accordance with certain aspects of the disclosure. The method may be performed by a UE (e.g., the UE 100, the apparatus 302/302′, 602/602′, 902/902′). In FIG. 5, operations indicated with dashed lines may represent optional operations for various aspects of the disclosure. In certain configurations, the operations illustrated in FIG. 5 may depend from one or more of the operations described supra with respect to FIGS. 2A and 2B or described infra with respect to FIGS. 8A and 8B.

At 502, the UE may receive a communication request to initiate a first wireless communication with a contact of the plurality of contacts or to initiate a second wireless communication with a number that is not associated with the plurality of contacts. For example, referring to FIG. 1C, the user (e.g. using the user's finger 105) may choose to initiate a communication with Aaron 113a. The user may choose to initiate a wireless communication with one of the contacts in the contact list 111 by interacting (e.g., contacts, taps, touches, depresses, swipes, etc.) a region associated with a particular contact in the contact list 111. Referring to FIG. 1C, the UE 100 may receive a request to initiate an initial communication with a number that is not associated with a contact in the contact list 111 accessible to the UE 100.

At 504, the UE may display a first set of communication parameters associated with initiating one of the first wireless communication or the second wireless communication using a first communication network associated with the first SIM card and a second set of communication parameters associated with initiating the one of the first wireless communication or the second wireless communication using a second communication network associated with the second SIM card. In one aspect, the first set of communication parameters may include at least one of a first cost per time unit associated with initiating the wireless communication using the first SIM card, a first prepaid balance associated with the first SIM card, a first signal strength of the first communication network associated with the first SIM card, a first indication of whether a first mobile number associated with the first SIM card has previously been used for at least one previous wireless communication with the contact, or first roaming information associated with initiating the wireless communication using the first communication network associated with the first SIM card. In another aspect, the second set of communication parameters may include at least one of a second cost per time unit associated with imitating the wireless communication using the second SIM card, a second prepaid balance associated with the second SIM card, a second signal strength of the second communication network associated with the second SIM card, a second indication of whether a second mobile number associated with the second SIM card has previously been used for at least one previous wireless communication with the contact, or second roaming information associated with initiating the wireless communication using the second communication network associated with the second SIM card. In a further aspect, the first set of communication parameters and the second set of communication parameters may include one or more communication parameters of a group of communication parameters. For example, referring to FIG. 1D, the ‘Signal Quality’ region 119a associated with SIM 1 indicates that SIM 1 may communicate with full signal strength (e.g., as indicated by all of the signal strength bars being shaded) and without roaming (e.g., as indicated by an absence of roaming symbol ‘R’). However, the ‘Signal Quality’ region 119b associated with SIM 2 indicates that SIM 2 may communicate with partial signal strength (e.g., as indicated by only two of the four signal strength bars being shaded). In addition, the ‘Signal Quality’ region 119b associated with SIM 2 indicates that the UE 100 is outside of a coverage area for the wireless communication network associated with SIM 2 and roaming (e.g., e.g., as indicated by the presence of roaming symbol ‘R’). As also depicted in the example illustrated in FIG. 1D, the ‘Shared Contact’ region 121a associated with SIM 1 indicates that the mobile number associated with SIM 1 has not been shared with the contact with whom the user wants to initiate a wireless communication. Further, the ‘Shared Contact’ region 121b associated with SIM 2 indicates that the mobile number associated with SIM 2 has been shared with the contact with whom the user wants to initiate a wireless communication. As further depicted in the example illustrated in FIG. 1D, the ‘Current Balance’ region 123a indicates that the prepaid balance associated with SIM 1 is $9.20 while the ‘Current Balance’ region 123b indicates that the prepaid balance associated with SIM 2 is $76.40. As additionally depicted in the example illustrated in FIG. 1D, the ‘Call Cost’ region 125a indicates that there are 40 free minutes (e.g., promotional minutes) available for use with the wireless communication network associated with SIM 1, and that the cost per minute associated with a wireless communication (e.g., voice call, video call, etc.) using SIM 2 is $0.2 per minute. Referring to FIG. 1C, when the UE 100 receives a request to initiate an initial communication with a number that is not associated with a contact in the contact list 111 accessible to the UE 100, the list of various communication parameters in the ‘SIM Selection Settings’ panel 103b (e.g., discussed supra with respect to FIG. 1B) may be displayed prior to initiating the initial communication.

At 506, the UE may receive an instruction to initiate the communication using one of the first communication network associated with the first SIM card or the second communication network associated with the second SIM card after the displaying the first set of communication parameters and the second set of communication parameters. For example, referring to FIG. 1D, based on the communication parameters displayed for each of SIM 1 and SIM 2, the user may choose to initiate the wireless communication by touching, swiping, and/or interacting with either SIM 1 region 117a (e.g., to initiate a communication using SIM 1) or SIM 2 region 117b (e.g., to initiate a communication using SIM 2). The UE 100 may receive the request for initiating a communication using SIM 1 or SIM 2 based on the user interaction.

At 508, the UE may initiate the communication based on the instruction. For example, referring to FIG. 1D, the UE 100 may initiate a communication using SIM 1 or SIM 2 based on the user interaction.

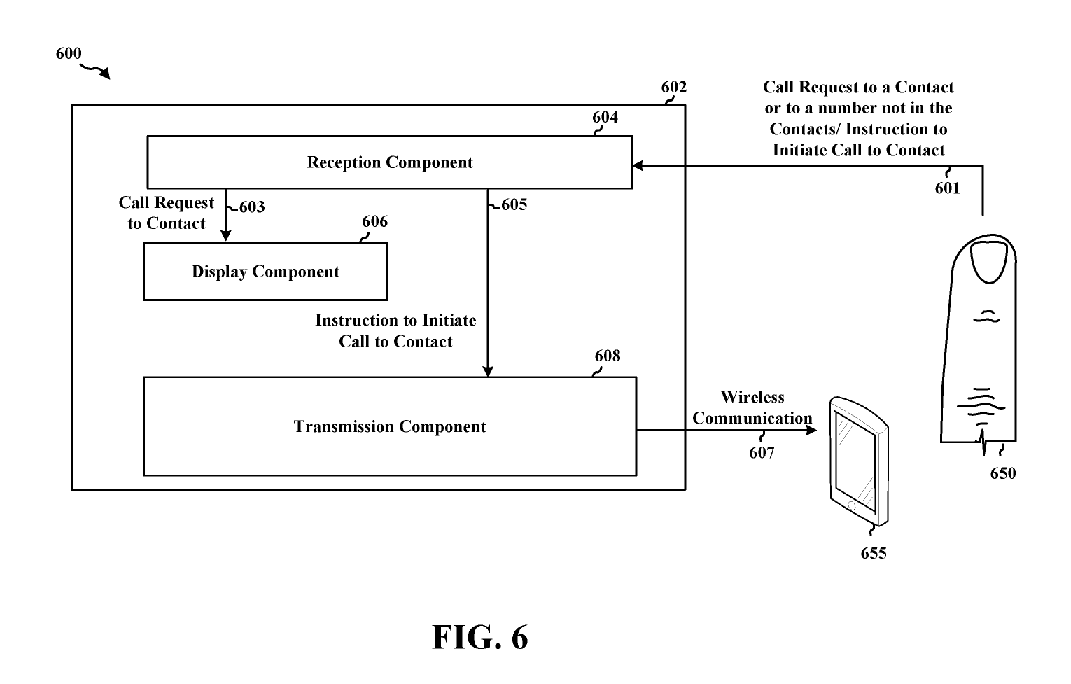

FIG. 6 is a conceptual data flow diagram 600 illustrating the data flow between different means/components in an exemplary apparatus 602. The apparatus may be a first UE (e.g., UE 100, apparatus 302/302′, 602′, 902/902′) that receives instructions from a user 650 and is in communication with a second UE 655. The apparatus includes a reception component 604 that may be configured to receive a communication request 601 to initiate a first wireless communication with a contact of the plurality of contacts or to initiate a second wireless communication with a number that is not associated with the plurality of contacts from the user 650. The reception component 604 may send a signal 603 associated with the communication request to a display component 606. The display component 606 may be configured to display a first set of communication parameters associated with initiating one of the first wireless communication or the second wireless communication using a first communication network associated with the first SIM card and a second set of communication parameters associated with initiating the one of the first wireless communication or the second wireless communication using a second communication network associated with the second SIM card. In one aspect, the first set of communication parameters may include at least one of a first cost per time unit associated with initiating the wireless communication using the first SIM card, a first prepaid balance associated with the first SIM card, a first signal strength of the first communication network associated with the first SIM card, a first indication of whether a first mobile number associated with the first SIM card has previously been used for at least one previous wireless communication with the contact, and first roaming information associated with initiating the wireless communication using the first communication network associated with the first SIM card. In another aspect, the second set of communication parameters may include at least one of a second cost per time unit associated with imitating the wireless communication using the second SIM card, a second prepaid balance associated with the second SIM card, a second signal strength of the second communication network associated with the second SIM card, a second indication of whether a second mobile number associated with the second SIM card has previously been used for at least one previous wireless communication with the contact, and second roaming information associated with initiating the wireless communication using the second communication network associated with the second SIM card. In a further aspect, the first set of communication parameters and the second set of communication parameters may include one or more communication parameters of a group of communication parameters. The reception component 604 may also be configured to receive an instruction to initiate the communication using one of the first communication network associated with the first SIM card or the second communication network associated with the second SIM card after the displaying the first set of communication parameters and the second set of communication parameters. Reception component 604 may send a signal 605 associated with the instruction to initiate a wireless communication to the transmission component 608. Transmission component 608 may initiate the wireless communication 607 based on the instruction. For example, the instruction may indicate that the communication is with the second UE 655.

The apparatus may include additional components that perform each of the blocks of the algorithm in the aforementioned flowchart of FIG. 5. As such, each block in the aforementioned flowchart of FIG. 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

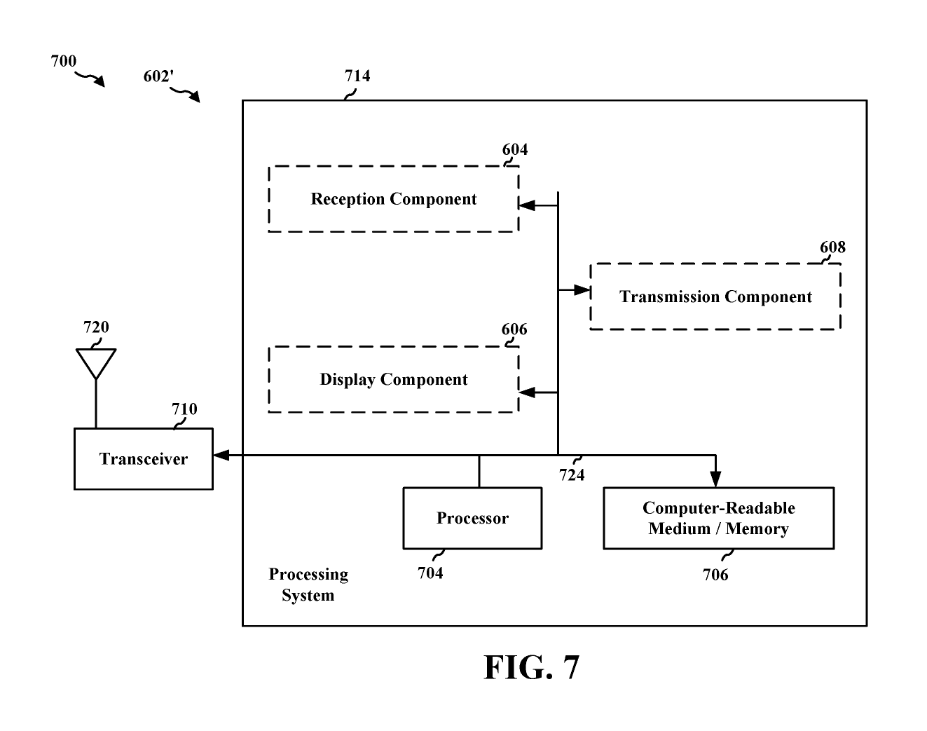

FIG. 7 is a diagram 700 illustrating an example of a hardware implementation for an apparatus 602′ employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware components, represented by the processor 704, the components 604, 606, 608, and the computer-readable medium/memory 706. The bus 724 may also link various other circuits such as timing sources, peripherals, voltage regulators, and power management circuits, which are well known in the art, and therefore, will not be described any further.

The processing system 714 may be coupled to a transceiver 710. The transceiver 710 is coupled to one or more antennas 720. The transceiver 710 provides a means for communicating with various other apparatus over a transmission medium. The transceiver 710 receives a signal from the one or more antennas 720, extracts information from the received signal, and provides the extracted information to the processing system 714, specifically the reception component 604. In addition, the transceiver 710 receives information from the processing system 714, specifically the transmission component 608, and based on the received information, generates a signal to be applied to the one or more antennas 720. The processing system 714 includes a processor 704 coupled to a computer-readable medium/memory 706. The processor 704 is responsible for general processing, including the execution of software stored on the computer-readable medium/memory 706. The software, when executed by the processor 704, causes the processing system 714 to perform the various functions described supra for any particular apparatus. The computer-readable medium/memory 706 may also be used for storing data that is manipulated by the processor 704 when executing software. The processing system 714 further includes at least one of the components 604, 606, 608. The components may be software components running in the processor 704, resident/stored in the computer readable medium/memory 706, one or more hardware components coupled to the processor 704, or some combination thereof.

In one configuration, the apparatus 602/602′ for wireless communication may include means for receiving a communication request to initiate a first wireless communication with a contact of the plurality of contacts or to initiate a second wireless communication with a number that is not associated with the plurality of contacts. In another configuration, the apparatus 602/602′ for wireless communication may include means for displaying a first set of communication parameters associated with initiating one of the first wireless communication or the second wireless communication using a first communication network associated with the first SIM card and a second set of communication parameters associated with initiating the one of the first wireless communication or the second wireless communication using a second communication network associated with the second SIM card. In one aspect, the first set of communication parameters may include at least one of a first cost per time unit associated with initiating the wireless communication using the first SIM card, a first prepaid balance associated with the first SIM card, a first signal strength of the first communication network associated with the first SIM card, a first indication of whether a first mobile number associated with the first SIM card has previously been used for at least one previous wireless communication with the contact, and first roaming information associated with initiating the wireless communication using the first communication network associated with the first SIM card. In another aspect, the second set of communication parameters may include at least one of a second cost per time unit associated with imitating the wireless communication using the second SIM card, a second prepaid balance associated with the second SIM card, a second signal strength of the second communication network associated with the second SIM card, a second indication of whether a second mobile number associated with the second SIM card has previously been used for at least one previous wireless communication with the contact, and second roaming information associated with initiating the wireless communication using the second communication network associated with the second SIM card. In a further aspect, the first set of communication parameters and the second set of communication parameters may include one or more communication parameters of a group of communication parameters. In a further configuration, the apparatus 602/602′ for wireless communication may include means for receiving an instruction to initiate the communication using one of the first communication network associated with the first SIM card or the second communication network associated with the second SIM card after the displaying the first set of communication parameters and the second set of communication parameters. In another configuration, the apparatus 602/602′ for wireless communication may include means for initiating the communication based on the instruction. The aforementioned means may be one or more of the aforementioned components of the apparatus 602 and/or the processing system 714 of the apparatus 602′ configured to perform the functions recited by the aforementioned means.

FIGS. 8A and 8B are a flowchart 200 of a method communication parameter selection for a multi-SIM UE in accordance with certain aspects of the disclosure. The method may be performed by a UE (e.g., the UE 100, the apparatus 302/302′, 602/602′, 902/902′). In FIGS. 8A and 8B, operations indicated with dashed lines may represent optional operations for various aspects of the disclosure. In certain configurations, the operations illustrated in FIGS. 8A and 8B may depend from one or more of the operations described supra with respect to FIGS. 2A and 2B and/or FIG. 5.

As seen in FIG. 8A, at 802, the UE may receive an initial request to initiate a wireless communication with a number that is not associated with a contact of the plurality of contacts. For example, referring to FIG. 1C, the UE 100 may receive a request to initiate an initial communication with a number that is not associated with a contact in the contact list 111 accessible to the UE 100.

At 804, the UE may display a set of communication parameters associated with initiating the wireless communication with the number that is not associated with a contact of the plurality of contacts using a first communication network associated with the first SIM card and a second communication network associated with the second SIM card. For example, referring to FIG. 1C, when the UE 100 receives a request to initiate an initial communication with a number that is not associated with a contact in the contact list 111 accessible to the UE 100, the list of various communication parameters in the ‘SIM Selection Settings’ panel 103b (e.g., discussed supra with respect to FIG. 1B) may be displayed prior to initiating the initial communication.

At 806, the UE may receive a selection of at least one first communication parameter of the set of communication parameters to display for each of the first communication network associated with the first SIM card and the second communication network associated with the second SIM card. For example, referring to FIG. 1C, the UE 100 may receive a selection (e.g., from the user) of communication parameters from the list of displayed communication parameters in the ‘SIM Selection Settings’ panel 103b.

At 808, the UE may maintain the selection of the at least one first communication parameter of the set of communication parameters to display for each of the first communication network associated with the first SIM card and the second communication network associated with the second SIM card. For example, referring to FIG. 1C, the UE 100 may maintain the selection of the communication parameters to display before initiating a communication with the number. For example, the UE 100 may maintain a list of the selected communication parameters using a RAM, a ROM, an EEPROM, optical disk storage, magnetic disk storage, other magnetic storage devices, and/or one or more external servers and/or databases. In certain aspects, the first selection of the at least one first communication parameter of the set of communication parameters to display for each of the first network associated with the first SIM card and the second communication network associated with the second SIM card may be maintained until the user changes and/or reconfigures the communication parameters to be displayed, or until the UE 100 automatically updates and/or reconfigures the communication parameters to be displayed.

As seen in FIG. 8B, at 810, the UE may receive a subsequent request to initiate a subsequent wireless communication with the number. For example, referring to FIG. 1C, the UE 100 may receive a subsequent request to initiate a subsequent communication with the number.

At 812, the UE may display the at least one first communication parameter of the set of communication parameters for each of the first communication network associated with the first SIM card and the second communication network associated with the second SIM card when the subsequent request to initiate the subsequent wireless communication with the number is received. For example, referring to FIG. 1C, when the UE 100 receives a subsequent request to initiate a subsequent communication with the number, the UE 100 may display the selected communication parameters (e.g., see FIG. 1D) that were selected before the initial communication without displaying the list of various communication parameters in the ‘SIM Selection Settings’ panel 103b for selection by the user.

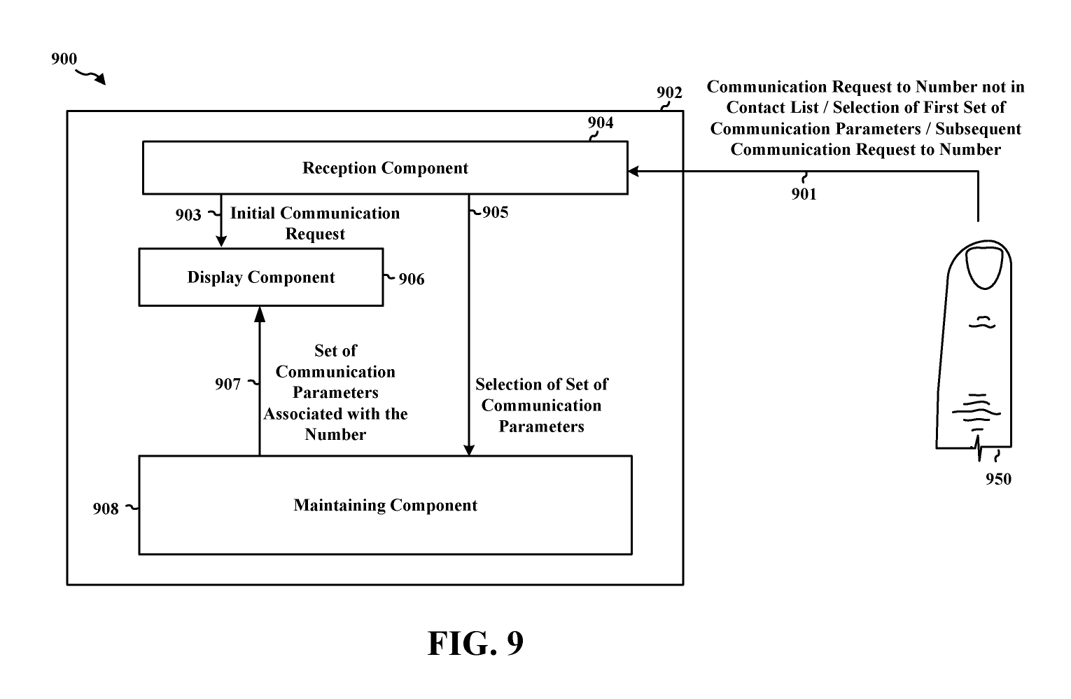

FIG. 9 is a conceptual data flow diagram 900 illustrating the data flow between different means/components in an exemplary apparatus 902. The apparatus may be a UE (e.g., UE 100, apparatus 302′, 602/602′, 902′) that receives communication requests 901 and/or selection information 901 from a user 950 (e.g., by user interaction with the apparatus 902). The apparatus may include a reception component 904, a display component 906, and/or a maintaining component 908. The reception component 904 may be configured to receive an initial request 901 to initiate a wireless communication with a number that is not associated with a contact of the plurality of contacts. In addition, the reception component 904 may send a signal 903 associated with the initial communication request to the display component 906. The display component 906 may be configured to display a set of communication parameters associated with initiating the wireless communication with the number that is not associated with a contact of the plurality of contacts using a first communication network associated with the first SIM card and a second communication network associated with the second SIM card. Further, the reception component 904 may be configured to may receive a selection of at least one first communication parameter of the set of communication parameters to display for each of the first communication network associated with the first SIM card and the second communication network associated with the second SIM card. The reception component 904 may be configured to send a signal 905 associated with the selection of the at least one first communication parameter to the maintaining component 908. The maintaining component 908 may be configured to maintain the selection of the at least one first communication parameter of the set of communication parameters to display for each of the first communication network associated with the first SIM card and the second communication network associated with the second SIM card. The reception component 904 may also be configured to receive a subsequent request to initiate a subsequent wireless communication with the number. Further, the reception component 904 may send a signal 905 associated with the subsequent request to the maintaining component. The maintaining component 908 may send a signal 907 associated with the set of parameters associated with the number to the display component 906. Further, the display component 906 may be configured to display the at least one first communication parameter of the set of communication parameters for each of the first communication network associated with the first SIM card and the second communication network associated with the second SIM card when the subsequent request to initiate the subsequent wireless communication with the number is received.

The apparatus may include additional components that perform each of the blocks of the algorithm in the aforementioned flowcharts of FIGS. 8A and 8B. As such, each block in the aforementioned flowcharts of FIGS. 8A and 8B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

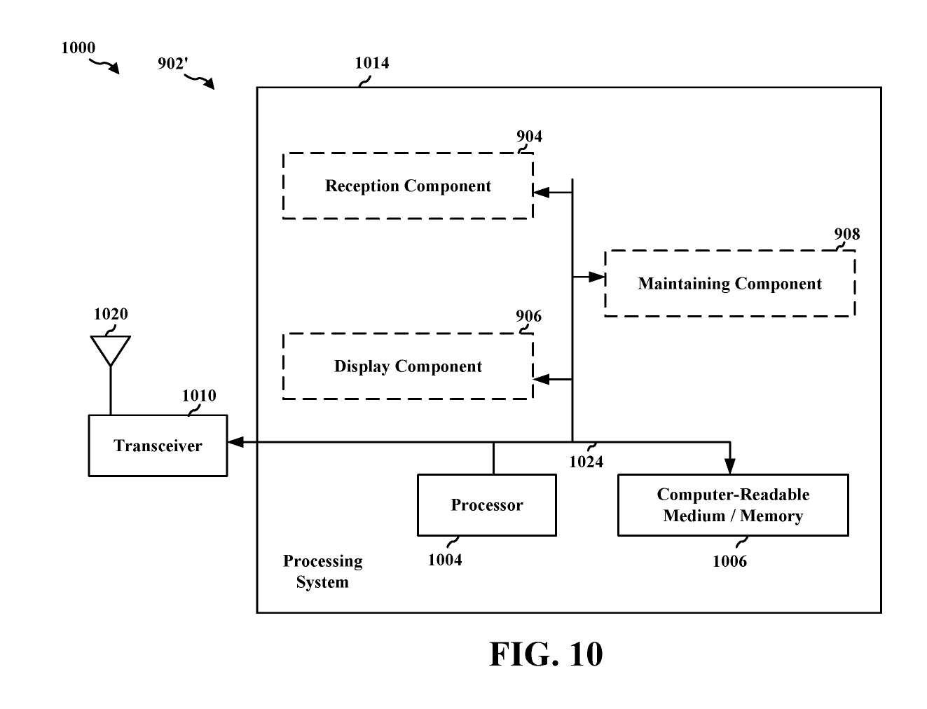

FIG. 10 is a diagram 1000 illustrating an example of a hardware implementation for an apparatus 902′ employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware components, represented by the processor 1004, the components 904, 906, 908, and the computer-readable medium/memory 1006. The bus 1024 may also link various other circuits such as timing sources, peripherals, voltage regulators, and power management circuits, which are well known in the art, and therefore, will not be described any further.

The processing system 1014 may be coupled to a transceiver 1010. The transceiver 1010 is coupled to one or more antennas 1020. The transceiver 1010 provides a means for communicating with various other apparatus over a transmission medium. The transceiver 1010 receives a signal from the one or more antennas 1020, extracts information from the received signal, and provides the extracted information to the processing system 1014, specifically the reception component 904. In addition, the transceiver 1010 receives information from the processing system 1014, and based on the received information, generates a signal to be applied to the one or more antennas 1020. The processing system 1014 includes a processor 1004 coupled to a computer-readable medium/memory 1006. The processor 1004 is responsible for general processing, including the execution of software stored on the computer-readable medium/memory 1006. The software, when executed by the processor 1004, causes the processing system 1014 to perform the various functions described supra for any particular apparatus. The computer-readable medium/memory 1006 may also be used for storing data that is manipulated by the processor 1004 when executing software. The processing system 1014 further includes at least one of the components 904, 906, 908. The components may be software components running in the processor 1004, resident/stored in the computer readable medium/memory 1006, one or more hardware components coupled to the processor 1004, or some combination thereof.

In one configuration, the apparatus 902/902′ for wireless communication may include means for receiving an initial request to initiate a wireless communication with a number that is not associated with a contact of the plurality of contacts. In another configuration, the apparatus 902/902′ for wireless communication may include means for displaying a set of communication parameters associated with initiating the wireless communication with the number that is not associated with a contact of the plurality of contacts using a first communication network associated with the first SIM card and a second communication network associated with the second SIM card. In a further configuration, the apparatus 902/902′ for wireless communication may include means for receiving a selection of at least one first communication parameter of the set of communication parameters to display for each of the first communication network associated with the first SIM card and the second communication network associated with the second SIM card. In one configuration, the apparatus 902/902′ for wireless communication may include means for maintaining the selection of the at least one first communication parameter of the set of communication parameters to display for each of the first communication network associated with the first SIM card and the second communication network associated with the second SIM card. In another configuration, the apparatus 902/902′ for wireless communication may include means for receiving a subsequent request to initiate a subsequent wireless communication with the number. In a further configuration, the apparatus 902/902′ for wireless communication may include means for displaying the at least one first communication parameter of the set of communication parameters for each of the first communication network associated with the first SIM card and the second communication network associated with the second SIM card when the subsequent request to initiate the subsequent wireless communication with the number is received. The aforementioned means may be one or more of the aforementioned components of the apparatus 902 and/or the processing system 1014 of the apparatus 902′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of communication parameter selection for a user equipment (UE), the UE including at least a first subscriber identity module (SIM) card and a second SIM card, and the UE having access to a plurality of contacts, the method comprising:
displaying a set of communication parameters associated with initiating a wireless communication using a first communication network associated with the first SIM card and a second communication network associated with the second SIM card;
receiving a first selection of at least one first communication parameter of the set of communication parameters to display upon receiving a selection of a contact from the plurality of contacts for each of the first communication network associated with the first SIM card and the second communication network associated with the second SIM card; and
maintaining the first selection of the at least one first communication parameter of the set of communication parameters to display upon receiving the selection of the contact from the plurality of contacts for each of the first communication network associated with the first SIM card and the second communication network associated with the second SIM card.

2. The method of claim 1, further comprising:
receiving a second selection of a first subset of contacts in the plurality of contacts to associate with the at least one first communication parameter of the set of communication parameters; and
maintaining the second selection of the first subset of contacts in the plurality of contacts with the at least one first communication parameter of the set of communication parameters.

3. The method of claim 2, further comprising:
receiving a third selection of at least one second communication parameter of the set of communication parameters to display for each of the first communication network associated with the first SIM card and the second communication network associated with the second SIM card;
receiving a fourth selection of a second subset of contacts in the plurality of contacts to associate with the at least one second communication parameter of the set of communication parameters; and
maintaining the fourth selection of the second subset of contacts in the plurality of contacts with the at least one second communication parameter of the set of communication parameters.

4. The method of claim 3, wherein:
the at least one first communication parameter for the first communication network associated with the first SIM card and the second communication network for the second SIM card is displayed when a communication request for a first contact in the first subset of contacts is received; and
the at least one second communication parameter for the first communication network associated with the first SIM card and the second communication network for the second SIM card is displayed when a communication request for a second contact in the second subset of contacts is received.

5. The method of claim 1, further comprising:
receiving an indication to display the set of communication parameters each time the selection of the contact from the plurality of contacts is received at the UE.

6. A method for wireless communication for a user equipment (UE), the UE including at least a first subscriber identity module (SIM) card and a second SIM card, and the UE having access to a plurality of contacts, the method comprising:
receiving a communication request to initiate a first wireless communication with a contact of the plurality of contacts or to initiate a second wireless communication with a number that is not associated with the plurality of contacts; and
displaying a first set of communication parameters associated with initiating one of the first wireless communication or the second wireless communication using a first communication network associated with the first SIM card and a second set of communication parameters associated with initiating the one of the first wireless communication or the second wireless communication using a second communication network associated with the second SIM card, wherein the communication request is to initiate the wireless communication with the number that is not associated with the plurality of contacts, and the first set of communication parameters and the second set of communication parameters includes a same set of communication parameters, the method further comprising:
receiving a selection of at least one first communication parameter of the same set of communication parameters to display after an entry of the number that is not associated with the plurality of contacts is received for each of the first communication network associated with the first SIM card and the second communication network associated with the second SIM card; and
maintaining the selection of the at least one first communication parameter of the same set of communication parameters to display after the entry of the number that is not associated with the plurality of contacts is received for each of the first communication network associated with the first SIM card and the second communication network associated with the second SIM card.

7. The method of claim 6, wherein the first set of communication parameters includes at least one of a first cost per time unit associated with initiating the one of the first wireless communication or the second wireless communication using the first SIM card, a first prepaid balance associated with the first SIM card, a first signal strength of the first communication network associated with the first SIM card, a first indication of whether a first mobile number associated with the first SIM card has previously been used for at least one previous wireless communication with the contact, or first roaming information associated with initiating the one of the first wireless communication or the second wireless communication using the first communication network associated with the first SIM card.

8. The method of claim 7, wherein the second set of communication parameters includes at least one of a second cost per time unit associated with initiating the one of the first wireless communication or the second wireless communication using the second SIM card, a second prepaid balance associated with the second SIM card, a second signal strength of the second communication network associated with the second SIM card, a second indication of whether a second mobile number associated with the second SIM card has previously been used for the at least one previous wireless communication with the contact, or second roaming information associated with initiating the one of the first wireless communication, or the second wireless communication using the second communication network associated with the second SIM card.

9. The method of claim 6, wherein the communication request is to initiate the wireless communication with the first contact of the plurality of contacts, the method further comprising:
receiving an instruction to initiate the first wireless communication using one of the first communication network associated with the first SIM card or the second communication network associated with the second SIM card after the displaying the first set of communication parameters and the second set of communication parameters; and
initiating the wireless communication based on the instruction.

10. The method of claim 6, wherein the first set of communication parameters and the second set of communication parameters include one or more communication parameters of a group of communication parameters.

11. (canceled)

12. The method of claim 6, further comprising:
receiving a subsequent request to initiate a subsequent wireless communication with the number; and
displaying the at least one first communication parameter of the same set of communication parameters for each of the first communication network associated with the first SIM card and the second communication network associated with the second SIM card when the subsequent request to initiate the subsequent wireless communication with the number is received.

13. An apparatus for communication parameter selection for a user equipment (UE), the UE including at least a first subscriber identity module (SIM) card and a second SIM card, and the UE having access to a plurality of contacts, the apparatus comprising:
a memory; and
at least one processor coupled to the memory and configured to:
display a set of communication parameters associated with initiating a wireless communication using a first communication network associated with the first SIM card and a second communication network associated with the second SIM card;
receive a first selection of at least one first communication parameter of the set of communication parameters to display upon receiving a selection of a contact from the plurality of contacts for each of the first communication network associated with the first SIM card and the second communication network associated with the second SIM card; and
maintain the first selection of the at least one first communication parameter of the set of communication parameters to display upon receiving the selection of the contact from the plurality of contacts for each of the first communication network associated with the first SIM card and the second communication network associated with the second SIM card.

14. The apparatus of claim 13, wherein the at least one processor is further configured to:
receive a second selection of a first subset of contacts in the plurality of contacts to associate with the at least one first communication parameter of the set of communication parameters; and
maintain the second selection of the first subset of contacts in the plurality of contacts with the at least one first communication parameter of the set of communication parameters.

15. The apparatus of claim 14, wherein the at least one processor is further configured to:
receive a third selection of at least one second communication parameter of the set of communication parameters to display for each of the first communication network associated with the first SIM card and the second communication network associated with the second SIM card;
receive a fourth selection of a second subset of contacts in the plurality of contacts to associate with the at least one second communication parameter of the set of communication parameters; and
maintain the fourth selection of the second subset of contacts in the plurality of contacts with the at least one second communication parameter of the set of communication parameters.

16. The apparatus of claim 15, wherein:
the at least one first communication parameter for the first communication network associated with the first SIM card and the second communication network for the second SIM card is displayed when a communication request for a first contact in the first subset of contacts is received; and
the at least one second communication parameter for the first communication network associated with the first SIM card and the second communication network for the second SIM card is displayed when a communication request for a second contact in the second subset of contacts is received.

17. The apparatus of claim 13, wherein the at least one processor is further configured to:
receive an indication to display the set of communication parameters each time the selection of the contact from the plurality of contacts is received at the UE.

18. An apparatus for communication parameter display for a user equipment (UE), the UE including at least a first subscriber identity module (SIM) card and a second SIM card, and the UE having access to a plurality of contacts, the apparatus comprising:
a memory; and
at least one processor coupled to the memory and configured to:
receive a communication request to initiate a wireless communication with a contact of the plurality of contacts; and
display a first set of communication parameters associated with initiating the wireless communication using a first communication network associated with the first SIM card and a second set of communication parameters associated with initiating the wireless communication using a second communication network associated with the second SIM card,
wherein the communication request is to initiate the wireless communication with the number that is not associated with the plurality of contacts, and the first set of communication parameters and the second set of communication parameters includes a same set of communication parameters, the method further comprising:
receiving a selection of at least one first communication parameter of the same set of communication parameters to display after an entry of the number that is not associated with the plurality of contacts is received for each of the first communication network associated with the first SIM card and the second communication network associated with the second SIM card; and
maintaining the selection of the at least one first communication parameter of the same set of communication parameters to display after the entry of the number that is not associated with the plurality of contacts is received for each of the first communication network associated with the first SIM card and the second communication network associated with the second SIM card.

19. The apparatus of claim 18, wherein the first set of communication parameters includes at least one of a first cost per time unit associated with initiating the wireless communication using the first SIM card, a first prepaid balance associated with the first SIM card, a first signal strength of the first communication network associated with the first SIM card, a first indication of whether a first mobile number associated with the first SIM card has previously been used for at least one previous wireless communication with the contact, or first roaming information associated with initiating the wireless communication using the first communication network associated with the first SIM card.

20. The apparatus of claim 19, wherein the second set of communication parameters includes at least one of a second cost per time unit associated with imitating the wireless communication using the second SIM card, a second prepaid balance associated with the second SIM card, a second signal strength of the second communication network associated with the second SIM card, a second indication of whether a second mobile number associated with the second SIM card has previously been used for at least one previous wireless communication with the contact, or second roaming information associated with initiating the wireless communication using the second communication network associated with the second SIM card.
